(19) United States
(12) Patent Application Publication
(10) Pub. No.: US 2006/0044576 A1
(43) Pub. Date: Mar. 2, 2006

(54) Apparatus for image processing

(75) Inventors: Sunao Tabata, Mishima-shi (JP); Hiroki Kanno, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/806,454

(22) Filed: Jul. 30, 2004

(51) Int. Cl. G06F 15/00

(52) U.S. Cl. 358/1.9; 358/448

(57) ABSTRACT

An image processing apparatus according to an embodiment of the present invention has a first compressing section which compresses each block of an image into first compressed data, a first code converting section which converts the first compressed data into second compressed data, a second code converting section which converts the second compressed data into third compressed data, and a decoding section which decodes the third compressed data. In this case, each block of the second compressed data has a code length equal to or different from that of each block of the first compressed data. Each block of the third compressed data has a code length equal to that of each block of the first compressed data.

### BACKGROUND OF THE INVENTION

1. Field of the Invention

The present invention relates to an apparatus for image processing which is effectively used in, for example, a digital copier.

2. Description of the Related Art

Some digital copiers have a single copying function with which a user manually places documents to be copied, in a scan section of the copier one by one and then copies the documents, and a continuous copying function to automatically sort large quantities of documents and then continuously copy them to a large number of sheets or continuously copy even only one document to a large number of sheets. Other digital copiers are equipped with an editing function to carry out editions (image synthesis, image reduction, and the like) utilizing temporarily saved data.

When the single copying function, the continuous copying function, or the editing function is executed, it is necessary to effectively utilize an image compressing process, a decoding process, and a process of accumulating data in a memory.

The documents listed below disclose image compressing techniques for copying apparatuses.

Document 1: Jpn. Pat. Appln. KOKAI Publication No. 10-271299, Document 2: Jpn. Pat. Appln. KOKAI Publication No. 11-69164, Document 3: U.S. application Ser. No. 10/310,800, Document 4: Jpn. Pat. Appln. KOKAI Publication No. 8-32781, Document 5: Jpn. Registered UM Publication No. 2520891, Document 6: Jpn. Registered UM Publication No. 3048158, Document 7: Jpn. Registered UM Publication No. 2537163

Document 1: Jpn. Pat. Appln. KOKAI Publication No. 10-271299

With the technique in Document 1, when input image data has binary values, it is divided into blocks, which are stored in a memory as they are. When the input image data has multiple values, each block of the data is subjected to fixed length coding as in the case of the binary data and is then stored in the memory as fixed length coded image data. This document also discloses a configuration used to store data in a second storage section different from the above memory by subjecting the binary data and multi-valued fixed length coded data to variable length coding to obtain variable length coded image data.

Document 2: Jpn. Pat. Appln. KOKAI Publication No. 11-69164

With the technique in Document 2, colored image data is subjected to fixed length coding and stored in a memory as fixed length coded image data. With the disclosed configuration, when the colored image data is stored in a hard disk (HDD) etc., it is subjected to variable length coding.

Document 3: U.S. application Ser. No. 10/310,800

With the technique in Document 3, image data is subjected to fixed length coding and stored in a memory as fixed length coded image data. If the data is stored in a hard disk (HDD), then while the fixed length coded image data is being decoded, it is converted into variable length coded image data composed of different codes. The disclosed configuration allows the same compressing technique to achieve both fixed length coding and variable length coding.

Document 4: Jpn. Pat. Appln. KOKAI Publication No. 8-32781

The technique in Document 4 uses means for estimating the level of degradation of image quality accompanying a decrease in the amount of information. With this technique, when the free capacity of storage means decreases, the amount of information in blocks determined to have their image quality minimally degraded is reduced by a binarizing process or the like.

Document 5: Jpn. Registered UM Publication No. 2520891

With the technique in Document 5, the amount of codes is adjusted depending on whether the document is colored or monochromatic. That is, when the document is monochromatic, the number of blocks stored in the memory is double that of blocks stored for colored images. Furthermore, when the document is monochromatic, a brightness higher than that for colored images is assigned to the document. That is, this technique increases the amount of codes for monochromatic documents.

Document 6: Jpn. Registered UM Publication No. 3048158

Document 6 discloses an ACS technique to determine whether an input image is colored or monochromatic. In order to avoid the impact of noise generated by an input system, this technique references a plurality of determination results for the respective pixels to correct the result of the determination as to whether the pixel is colored or monochromatic. Then, the corrected results of determination are aggregated for the entire image to determine whether the input image is colored or monochromatic.

Document 7: Jpn. Registered UM Publication No. 2537163

The technique in Document 7 is a system that operates for color printing to scan a document four times to compress the data in it and then transmit the data to a printer section, where a drum is rotated four times for printing. This technique determines the number of color planes constituting one image (for example, whether or not only a K plane is to be used). If it is determined that only the K plane is to be used, one scanning operation, one compressing operation, and one printing operation are performed for the K plane. This serves to improve the scan and printing performance.

As described above, for copying apparatuses, plural types of compressing and decoding techniques, data storing techniques, data determining techniques, and the like have been developed. However, there are no apparatuses that integrate these techniques together to provide high performance.

### BRIEF SUMMARY OF THE INVENTION

As described above, for copying apparatuses, plural types of compressing and decoding techniques, data storing techniques, data determining techniques, and the like have been developed. However, there are no apparatuses that integrate these techniques together to provide high performance.

It is thus an object of the present invention to provide an apparatus for image processing which effectively utilizes diverse compressing and decoding systems, that is, selectively applies a plurality of compressing systems or combines them with each other to improve accumulation efficiency while allowing image data to be properly edited.

According to an embodiment of the present invention, an apparatus for image processing has a first compressing section which compresses each of block of an image into first compressed data, a first code converting section which converts the first compressed data into second compressed data, a second code converting section which converts the second compressed data into third compressed data, and a decoding section which decodes the third compressed data. The second compressed data is obtained by converting the first compressed data so that each block of the second compressed data has a code length equal to or different from that of each block of the first compressed data. Each block of the third compressed data has a code length equal to that of each block of the first compressed data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a block diagram showing an example of a general configuration according to a first embodiment of the present invention;

FIG. 2 is a diagram showing an example of the configuration of a compressing section shown in FIG. 1;

FIG. 3 is a diagram showing an example of the configuration of an entropy coding section of the compressing section shown in FIG. 1;

FIG. 4 is a diagram showing an example of the configuration of an ACS in FIG. 1;

FIG. 5 is a diagram showing an example of the configuration of a first code converting section in FIG. 1;

FIG. 6 is a diagram showing an example of the configuration of a second code converting section in FIG. 1;

FIGS. 7A to 7C are schematic diagrams showing how the first and second code converting sections convert data;

FIG. 8 is a diagram showing another example of the configuration of a decoding section according to Embodiment 1;

FIG. 9 is a diagram illustrating a data converting operation of a code changing section of the decoding section in FIG. 8;

FIG. 10 is a diagram of yet another embodiment of the ACS, showing an example of the configuration of a combination of an entire ACS and a block ACS;

FIG. 11 is a table illustrating an example of a total determination made by of the ACS in FIG. 10 using a document mode and the entire ACS and block ACS;

FIG. 12 is a diagram showing an example of the configuration of another embodiment of the present invention;

FIG. 13 is a diagram showing an example of the configuration of a plane determining section in FIG. 12;

FIG. 14 is a diagram showing an example of the configuration of a compressing section in FIG. 12;

FIGS. 15A to 15C are diagrams illustrating the data amount reducing effect of the embodiment in FIG. 12;

FIG. 16 is a diagram showing an example of the configuration of still another embodiment of the present invention;

FIG. 17 is a diagram showing an example of the configuration of further another embodiment of the present invention;

FIG. 18 is a diagram showing an example of the configuration of yet another embodiment of the present invention;

FIGS. 19A to 19C are diagrams illustrating an example of an operation of the configuration shown in FIG. 18, the operation being performed if a mixture of compression formats is used;

FIGS. 20A to 20D are diagrams illustrating an operation of the embodiment shown in FIG. 18, the operation being performed if compression formats with different processing units are processed;

FIGS. 21A to 21E are diagrams illustrating a processing operation performed if data and a printing direction are known in the embodiment shown in FIG. 18;

FIG. 22 is a diagram showing an example of the configuration of a variation of the embodiment shown in FIG. 18;

FIGS. 23A to 23D are diagrams illustrating an example of an operation of a code converting section 2010e1 according to another variation of the embodiment shown in FIG. 18; and

FIG. 24 is a diagram showing an example of the configuration of further another embodiment of the present invention.

### DETAILED DESCRIPTION OF THE INVENTION

Hereinafter, embodiments of the present invention will be explained in detail with reference to the attached drawings.

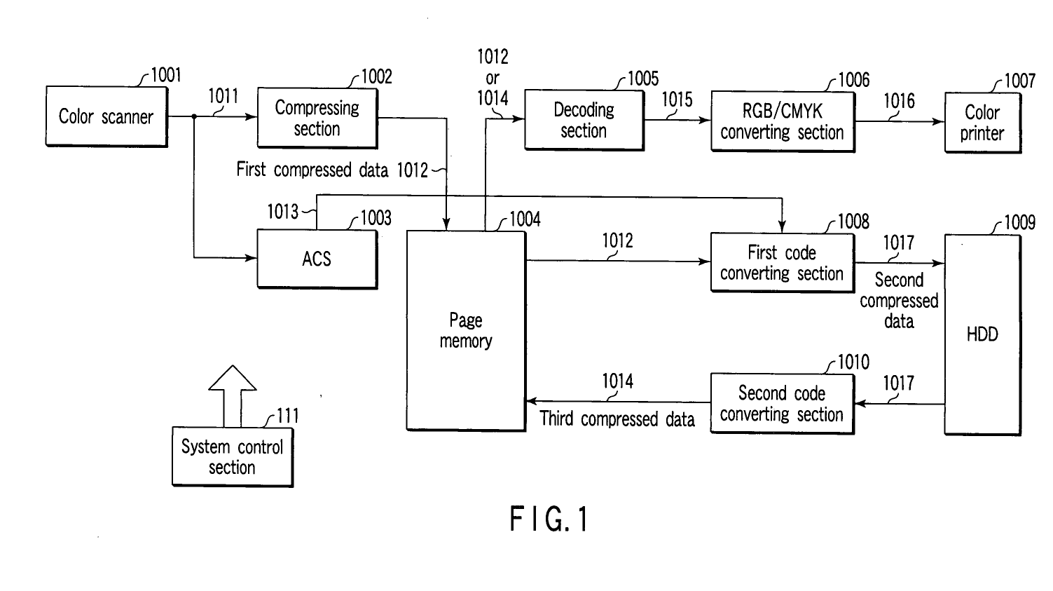

FIG. 1 shows an embodiment of the present invention. Reference numeral 1001 denotes a color scanner. A colored image signal 1011 read by the color scanner 1001 is inputted to a first compressing section 1002 and to an auto color selector (ACS) 1003. First compressed data 1012 outputted by the first compressing section 1002 is inputted to a page memory 1004. The ACS 1003 determines whether the input image is colored or monochromatic and then outputs a determination signal 1013.

Image data (compressed data 1012 or 1014) read from the page memory 1004 can be inputted to a decoding section 1005. A decoded signal 1015 decoded by the decoding section 1005 is inputted to an RGB/CMYK converting section 1006 to convert an R (red), G (green), and B (blue) signals into a C (cyan), M (magenta), Y (yellow), and K (black) signals. The C, M, Y, and K signals are inputted to a color printer 1007.

The first compressed data 1012 read from the page memory 1004 can also be inputted to a first code converting section 1008. The first code converting section 1008 converts the first compressed data 1012 into second compressed data 1017. The second compressed data 1017 is inputted to a hard disk device (HDD) 1009 and stored in a hard disk.

A second code converting section 1010 subjects the second compressed data 1017 outputted by the hard disk device 1009 to a code conversion. The second code converting section 1010 then outputs third compressed data 1014 and supplies it to the page memory 1004. A system control section 111 controls blocks that implement the above various functions.

The present apparatus is a colored image output apparatus. For single copying, the compressing section 1002 converts data on an image loaded by the scanner 1001, into fixed length data. The fixed length data is then stored in the page memory 1004. Subsequently, the fixed length data in the page memory 1004 is read out for editions such as a rotating process. The data is thus decoded. The decoded image data is subjected to a color conversion to obtain a signal that can be printed by the printer 1007 as an image. Then, a printout is obtained.

In an electronic sort mode, the scanner 1001 sequentially loads documents and compresses image data. The first code converting section 1008 converts the compressed data and stores the converted data in the hard disk device 1009. The second compressed data 1017 for the required documents are sequentially read from the hard disk. The second code converting section 1010 converts the read data into the third compressed data 1014. The decoding section 1005 then decodes the converted data. Then, the decoded data is subjected to a color conversion. Finally, the converted data is printed.

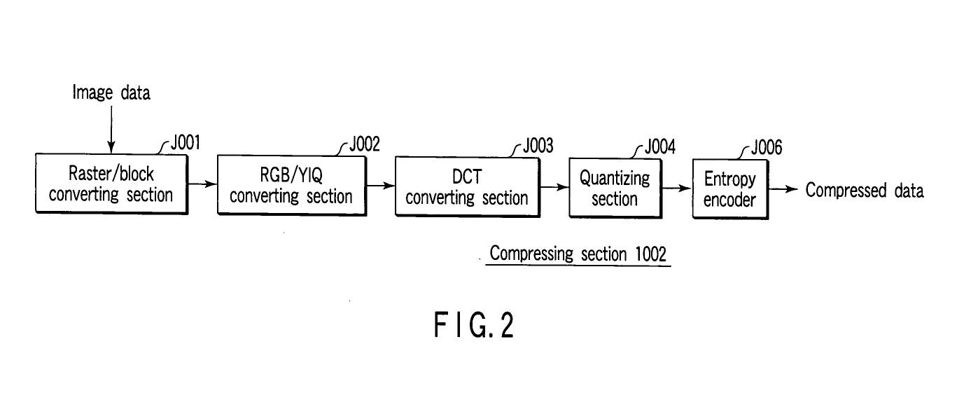

FIG. 2 shows an example of the configuration of the compressing section 1002. A raster/block converting section J001 converts each line of image data into 8×8 block data. Then, an RGB/YIQ converting section J002 converts an RGB image signal that is the block data, into a YIQ image signal. Then, a DCT (Discrete Cosine Transformation) section J003 executes a DCT process on each 8×8 block of each YIQ signal. A quantizing section J004 then quantizes the data subjected to the DCT process, in accordance with a DCT function. An entropy coding section J006 then subjects the quantized data to 0 run length compression and Huffman coding so as to cover low to high frequencies.

The above process blocks correspond to respective compressing techniques focusing on the following characteristics.

The raster/block converting section: this section executes a frequency conversion on an image to compresses it, and can thus convert each block of the data so that the block can be handled as two dimensional data that can be efficiently compressed.

The RGB/YIQ converting section: this section converts the data into a luminance/color difference system because human beings are visually characterized by being more sensitive to differences in brightness than in color.

The DCT converting section: this section converts an image signal into a frequency signal for compression.

The quantizing section: in view of the human visual characteristics, this section carries out quantization so as to reduce the amount of data in a color difference signal rather than in a luminance signal and to reduce the amount of data in a high frequency signal rather than in a low frequency signal (so that the quantization results in a larger number of zeros).

The entropy coding section: since the number of zeros increases consistently with the frequency, this section executes run length coding and Huffman coding by arranging frequency components in order of ascending frequency.

The above apparatus lacks a DC block differential calculating section that calculates the output from the DCT converting section J003, which is present in conventional compressing sections. This is because a data rotating process is to be executed on the page memory 1004 by omitting the DC block differential calculating section. If an image is to be subjected to a rotating process, the relationship between a vertical direction and a horizontal direction varies. Accordingly, it is impossible to simply use data on the difference between adjacent blocks.

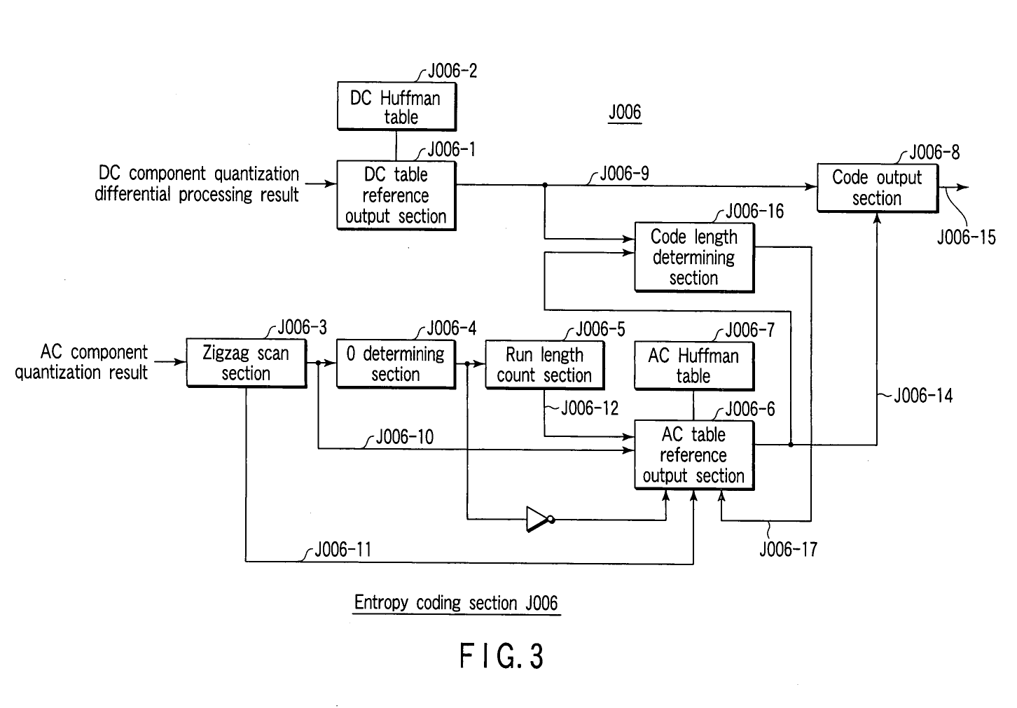

FIG. 3 shows an example of the configuration of the entropy coding section J006 (the coding section shown in FIG. 2) according to the present invention. The results of quantization of a DC component form the quantizing section J004 are inputted to a DC table reference output section J006-1. On the basis of the results of quantization of the DC component, the DC table reference output section J006-1 outputs a DC component code J006-9 with reference to a DC Huffman table J006-2. The results of quantization of an AC component are inputted to a zigzag scan section J006-3. The zigzag scan section J003-3 outputs a frequency component J006-10 obtained by sequentially zigzag-scanning low to high frequencies of an AC component as well as a scan termination signal J006-11 indicating whether or not one block has been completely scanned (=1).

A 0 determining section J006-4 determines whether the frequency component J006-10 is zero (=1) or non-zero. The 0 determining section J006-4 outputs and provides a determination signal J006-12 to a run length count section J006-5. The rung length count section J006-5 counts 0 runs.

An AC table reference output section J006-6 uses the value of a 0 run length and a non-zero value to reference an AC Huffman table J006-7. The AC table reference output section J006-6 thus generates and outputs an AC component code J006-14 corresponding to the value of the 0 run length and the non-zero value.

An AC table is coded in the following cases:
1) when non-zero data is detected.
2) when the terminal of the frequency is detected.

In the case of 1), coded data is obtained by combining the non-zero with the run length of zeros prior to the non-zero. However, if the run length is at least 16, the coded data is represented using a plurality of (a multiple of the run length of 16) ZRL codes, the non-zero, and the code for the remaining run length.

In the case of 2), for non-zero data, the rule 1) is used. For zero data, the coded data comprises an EOB code indicating that zeros run successively to the terminal of the block.

During coding, the run length count section J006-5 is reset to 0. A code output section J006-8 combines the DC component code J006-9 with the AC component code J006-14 for each block and outputs the resultant code data J006-15. For a colored image, operations similar to those described above are normally performed on each of the Y, I, and Q planes.

A code length determining section J006-16 uses the DC component code J006-9 and the AC component code J006-14 to determine whether or not the amount of codes in a block is equal to or less than a threshold. The code length determining section J006-16 outputs a code length determination signal J006-17 and inputs it to the AC table reference output section J006-6.

The code length determining section J006-16 outputs 1 if the DC and AC exceed coding thresholds. When the code length determination signal J006-17 is 1, the AC table reference output section J006-6 forcedly converts the code being processed into an EOB to end coding the block. The process then shifts to the next block. Therefore, in this case, the code length is defined. The code output section J006-8 stores the code in a 0-cleared predetermined memory format and adds an identification code “1” to the terminal of the code.

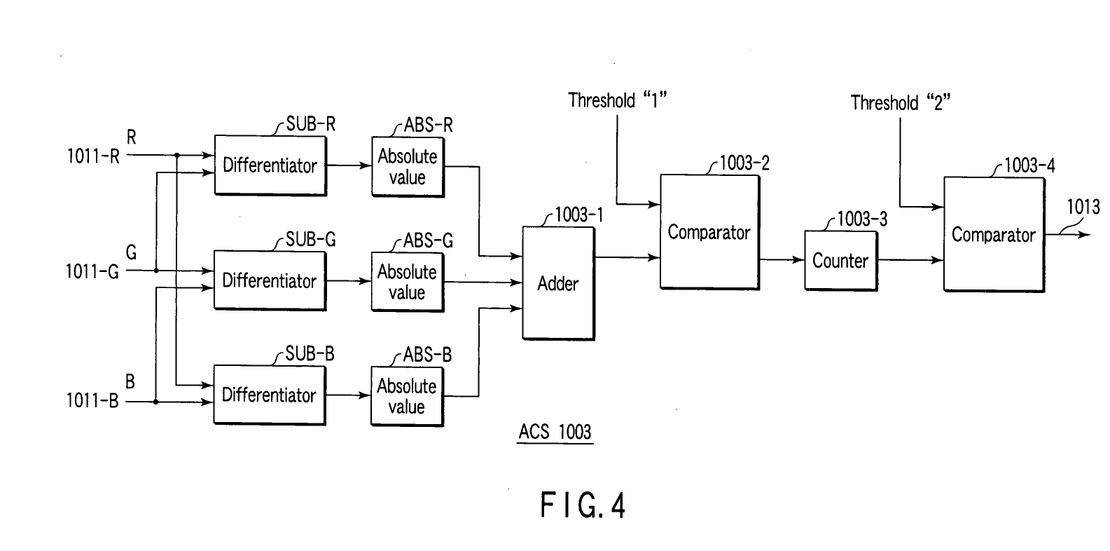

FIG. 4 shows an example of the configuration of the ACS 1003. The color scanner 1001 outputs an R signal 1011-R, a G signal 1011-G, and a B signal 1011-B. The R signal is inputted to differentiator SUB-R and a differentiator SUB-B. The G signal is inputted to a differentiator SUB-G and the differentiator SUB-R. The B signal is inputted to the differentiator SUB-B and the differentiator SUB-G. Outputs from the differentiators SUB-R, SUB-G, and SUB-B are inputted to absolute value circuits ABS-R, ABS-G, and ABS-B, respectively. An adder 1003-01 adds up absolute value outputs and inputs an addition output to a comparator 1003-02. The addition output is the sum of the absolute values of the differentials between the colored image signals R, G, and B, that is, |R-G|+|G-B|+|B-R|. The comparator 1003-02 compares the addition output with a threshold “1” to output “1” for a colored image and “0” for a monochromatic image.

A counter 1003-2 counts the output results. Once the data on the entire image has undergone comparison, a comparator 1003-4 compares the count with a threshold “2”. Then, the comparator 1003-4 outputs a determination signal 1013. The outputted determination signal 1013 is “1” if the entire image is determined to be colored, and is “0” if the entire image is determined to be monochromatic.

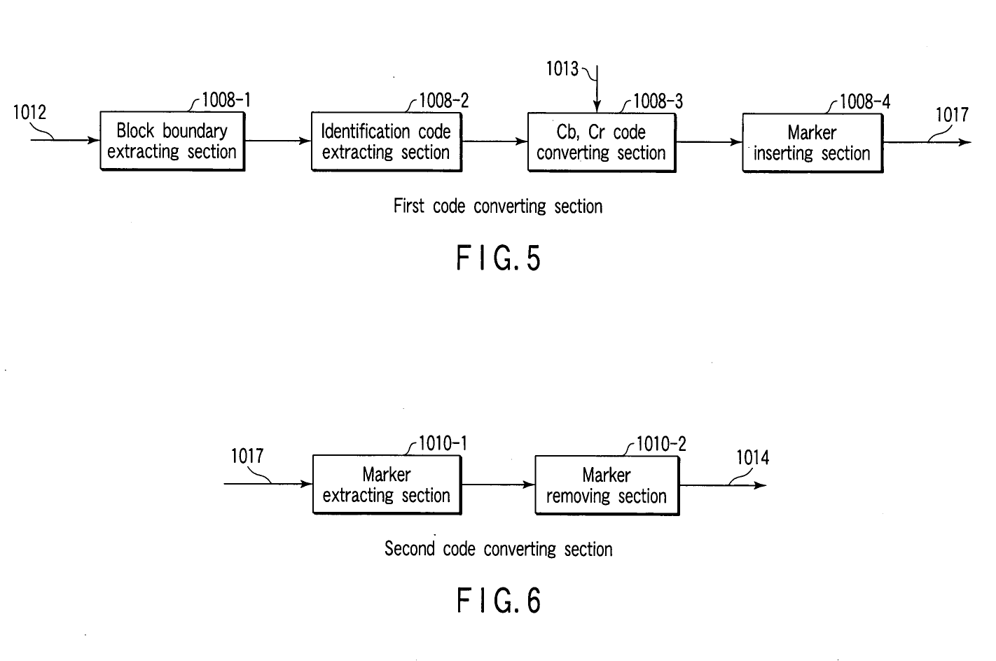

FIG. 5 shows an example of the configuration of the first code converting section 1008. The first code converting section 1008 uses a block boundary extracting section 1008-1 to extract a code boundary of each block of the first compressed data 1012. The block boundary can be extracted from the first compressed data 1012 by a simple address calculation because the data 1012 has been compressed so that each block of it has the same code length. Then, an identification code extracting section 1008-2 scans forward from the trailing end of the code boundary of the block to extract an identification code “1”. The identification code can be easily extracted because at the trailing end of the block, zeros are arranged successively up to the identification code.

When the determination signal 1013, which indicates the result of the color determination, is “1”, a CbCr code converting section 1008-3 inserts a color determination “1” in front of the identification code for a Y component. However, when the determination signal 1013 is “0”, the CbCr code converting section 1008-3 inserts the color determination “0” and removes a CbCr block. This corresponds to points (P1) and (P3), characteristic points of the present apparatus.

The format of the first compressed data is coded so that the entropy coding section J006 can insert 1-bit information into the data. Specifically, for 32 bits, the entropy coding section first calculates a code containing 31 bits and then inserts “1” in front of the identification code so that the entire code contains 32 bits. A marker inserting section 1008-4 places a marker behind the identification code which is used for JPEG header information. The marker inserting section 1008-4 outputs the code up to the trailing end of the marker as the second compressed data 1017.

The JPEG makes it a rule that the marker is placed at a byte boundary. Accordingly, if the terminal of the marker is not a byte boundary, “0” is inserted between the identification code and the marker so that the terminal of the marker is a byte boundary.

FIG. 6 shows the second code converting section 1010, which performs operations that are opposite to those of the first code converting section 1008. Specifically, a marker extracting section 1010-1 extracts the marker from the second compressed data 1017. Then, a marker removing section 1010-2 removes the marker. Then, the second code converting section 1010 places Os behind the identification code “1” until a predetermined code length is reached, to obtain and output the third compressed data 1014. This corresponds to points (P1) and (P3), characteristic points of the present apparatus, described later.

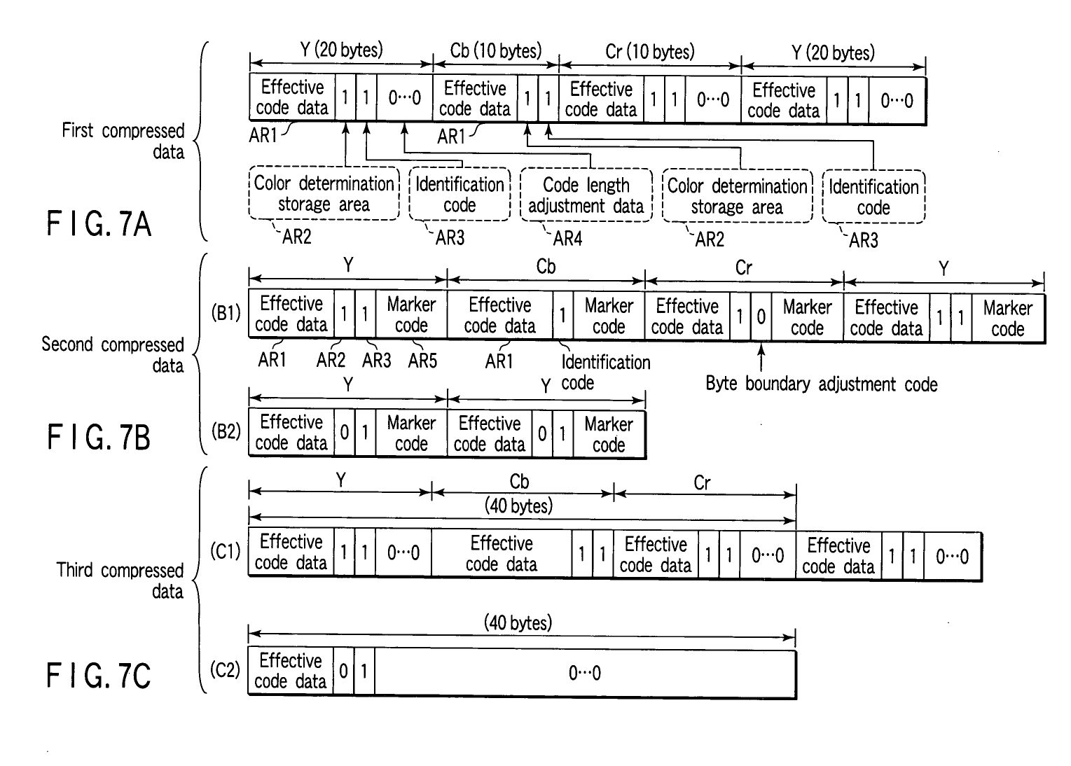

FIGS. 7A to 7C show how the first compressed data 1012 and second compressed data 1017, described above, are converted.

The format of the first compressed data 1012 is in blocks as shown in FIG. 7A. Each block must contain data with a predetermined code length. In this example, Y (luminance signal)=20 bytes, Cb (color difference signal)=10 bytes, and Cr (color difference signal)=10 bytes. Thus, the data block has a total code length of 40 bytes. Each of the Y, Cb, and Cr signals has an effective code data storage area (AR1), a color determination code storage area (AR2), an identification code storage area (AR3), and a code length adjustment data storage area (AR4).

The format of the second compressed data 1017 is as shown in (B1) or (B2) of FIG. 7B. In the example in (B1) of FIG. 7B, each of the Y, Cb, and Cr signals has the effective code data storage area (AR1), the color determination code storage area (AR2), and the identification code storage area (AR3). A marker insertion area (AR5) is provided next to the identification code storage area (AR3). The marker is inserted and the code length adjustment data is cut, compared to the first compressed data 1012. It is a rule that the marker is placed at the byte boundary. Accordingly, if the terminal of the marker is not the byte boundary, “0s” are inserted between the identification code and the marker so that the terminal of the marker is the byte boundary (an example is shown in Cr in (B1) of FIG. 7B)

The example in (B2) of FIG. 7B is composed of only the Y signal. In this case, the result of the determination indicates that the image is monochromatic. In this case, the color determination result “0” is inserted into the Y block, with the Cb and Cr blocks removed.

The format of the third compressed data 1014 is as shown in (C1) and (C2) of FIG. 7C. For a colored image signal, the same format as that shown in FIG. 7A is used. For a monochromatic image signal, the format is composed of only the Y signal. However, code length adjustment data is inserted to makes the entire code length the same as that shown in FIG. 7A.

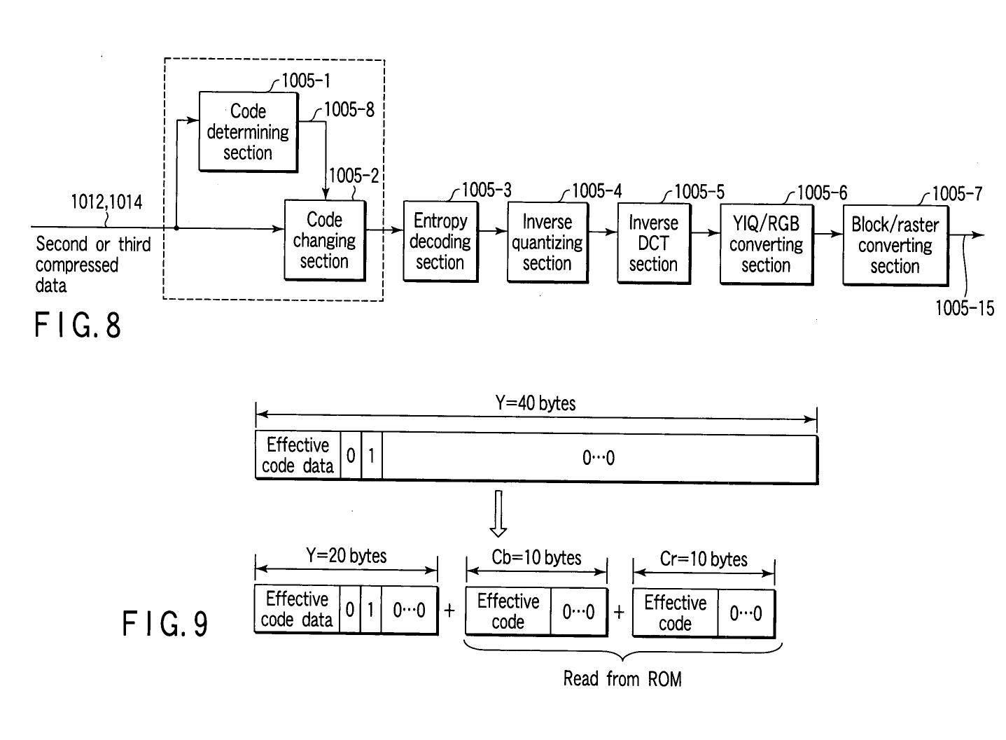

FIG. 8 shows an example of the configuration of the decoding section 1005. The decoding section 1005 carries out a conversion opposite to compression. The second compressed data 1012 or third compressed data 1004 from the page memory 1004 is inputted to an input section. The compressed data is inputted to a code determining section 1005-1 and a code changing section 1005-2. The code determining section 1005-1 searches the first compressed data 1012 or third compressed data 1014 for a color determination area to extract a determination signal 1005-8 indicating whether the result of the determination is “1” or “0”. The code determination result 1005-8 outputted by the code determining section 1005-1 is supplied to the code changing section 1005-2. If the signal 1005-8 is “1”, the code changing section 1005-2 inputs the first compressed data 1012 or the third compressed data 1014 to an entropy decoding section 1005-3 as it is. If the signal 1005-8 is “0”, the code changing section 1005-2 reads Cb and Cr components (20 bytes in total) from a ROM (Read Only Memory) and places them behind a Y component (in the example, 20 bytes) as shown in FIG. 9. The code changing section 1005-2 then changes the order of the data and then inputted the processed data to the entropy decoding section 1005-3. An inverse quantizing section 1005-4 inversely quantizes an output from the entropy decoding section 1005-3. Then, an inverse DCT section 1005-5 subjects the inversely quantized output to an inverse DCT. Then, a YIQ/RGB inverse converting section 1005-6 and a block/raster converting section 1005-7 decode the inverse DCT output into the original image data. In this connection, handling of a JPEG standard data requires header information on compression. However, since the header information is required only to transmit and receive compressed data as a file, it will not be described herein unless otherwise required.

In the process of this apparatus, the image quality of an image determined to be monochromatic is not substantially affected provided that the ROM stores data subjected to fixed length coding with the Cb and Cr components set to 0. This corresponds to a point (P5), a characteristic point of the present apparatus, described later.

In the present example, the decoding section 1005 assigns code data in a colored format to image data determined to be monochromatic. However, the second code converting section 1010 may adjust the data CbCr=0, the colored format for monochromatic data, to a code length of 10 bytes and place the data of this code length behind the 20-byte code data of the Y component. In this case, the decoding section 1005 can successfully achieve decoding even if the color determination signal remains “0”. This corresponds to a point (P4), a characteristic point of the present apparatus, described later.

To decode fixed length data, the entropy decoding section 1005-3 decodes each block of the data. After completing the decoding, the entropy decoding section 1005-3 processes the next block starting with its leading address. In this case, during the decoding process, the identification code and the information on the result of the color determination are neglected. Consequently, the Cb and Cr do not affect the decoded image.

As described above, the apparatus according to the present invention reduces the amount of second compressed data more drastically than the amount of first compressed data. Moreover, for the second compressed data, the Cb and Cr components are removed for a monochromatic image, resulting in a sharply reduced amount of data.

Furthermore, the default value (for single copying in which the first code converting section 1008 is not used) of the color determination result is “1”, and the Cb and Cr are not processed during decoding. That is, compressed data is decoded as it is. Consequently, either for single copying or for electronic sorting, decoding can be achieved without the need to switch the processing form of the decoding section 1005. This corresponds to a characteristic point (P2) of the present apparatus, described later.

In the present example, description has been given of the configuration that switches the format of the compressed data in accordance with the ACS determination result as shown in FIGS. 7A to 7C. However, the format of the compressed data may be switched in accordance with a document mode specified by a user. In this case, the degradation of image quality resulting from the removal of the color components (Cb and Cr) can be prevented by subjecting the image data to color equation (for example, R=G=B=(R+G+B)÷3) before the image data compressing. This corresponds to a point (P6), a characteristic point of the present apparatus described later.

The code changing process (described in FIGS. 8 and 9) executed during decoding comprises simply recognizing the color determination result. Accordingly, when the document type (compressed data) described below is decoded, the operation can be performed without switching parameters. For example, Ninl and the like enable a plurality of document types to be easily mixed together in a single output sheet. This indicates that printing can be more freely executed.
The ACS determines the image to be colored: the data is inputted in colors, and the determination signal 1013 is “1” on the basis of the ACS result.
The ACS determines the image to be monochromatic: the data is inputted in colors, and the determination signal 1013 is “0” on the basis of the ACS result.
Color specification: the data is inputted in colors, and the determination signal 1013 is forced to be “1”.
Monochromatic specification: the data is subjected to color equation before compression, and the determination signal 1013 is forced to be “0”.

Furthermore, the present system uses a consistent basic amount of monochromatic information and a consistent basic amount of information on monochromatic areas included in a colored image. It is thus possible to print an image while minimizing a variation in image quality which may occur depending on the mode.

The decoding section 1005 can equally decode the first compressed data 1012 (for single copying) and the third compressed data 1014 (for electronic sorting). It is thus easy to print a mixture of the first compressed data 1012 and the third compressed data 1014 (data from the HDD is printed beside data for single copying). This corresponds to a point (P7), a characteristic point of the present apparatus, described later.

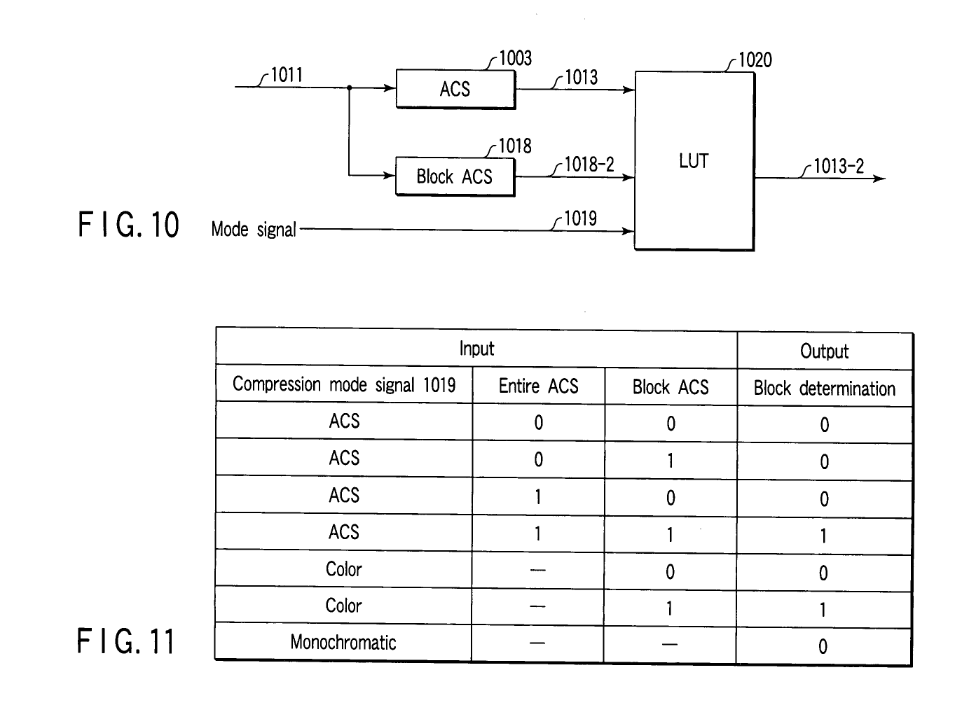

FIG. 10 shows another embodiment of an ACS determination. This example is a combination of an entire ACS determination in which determination is made for the entire image and a block ACS determination in which an ACS determination is made for each compressed block. The entire color determination signal is inputted to the first code converting section 1008 as a final determination signal 1013-2 as shown in FIG. 10. This system further improves the code reducing effect and provides as free combinations as in the case of the entire image. This corresponds to points (P8) and (P12), characteristic points of the present apparatus described later.

Specifically, a block ACS 1018 executes an ACS determination on each compressed block (small units) and outputs a determination result 1018-2. The other arrangements are the same as those of the ACS 1003 and will thus not be described. If the block ACS 1018 produces an ACS determination result directly from the image signal 1011, it is necessary to provide a memory storing the determination results for the entire image, which correspond to the respective blocks. However, the need for the extra memory can be eliminated by storing the determination results in a color determination area (1 bit) provided in the compressing section 1002. This corresponds to a point (P10), a characteristic point of the present apparatus described later.

In this case, if the first code converting section 1008 processes the color determination result for the entire image, produced by the ACS 1003, together with the color determination result for each compressed block, it reads and examines the color determination results (block unit ACS determination results) stored in the first compressed data 1012, together with the entire color determination result produced by the ACS 1003. The determination signal 1013 and the block color determination result 1018-2 are inputted to a lookup table 1020. A mode signal 1019 is also inputted to the lookup table 1020.

The lookup table 1020 executes a logic determination such as the one shown in FIG. 11. In FIG. 11, the compression mode signal 1019 determines the operation mode of the lookup table 1020. If an ACS determination is executed, the mode signal 1019 is an ACS specified signal. If a forced color process is specified, the mode signal 1019 is a color specified signal. If a forced monochromatic process is specified, the mode signal 1019 is a monochromaticity specified signal. When the ACS determination is specified and if the entire color determination result and the block color determination result are (0, 0), the final color determination result for the block unit is “0”. If the entire color determination result and the block color determination result are (0, 1), the final color determination result for the block unit is “0”. If the entire color determination result and the block color determination result are (1, 0), the final color determination result for the block unit is “0”. If the entire color determination result and the block color determination result are (1, 1), the final color determination result for the block unit is “1”.

When the mode signal 1019 indicates a color specification, only the block color determination result 1018-2 is employed. When the mode signal 1019 indicates a monochromaticity specification, the final determination signal 1013-2 is always “0”. This corresponds to a point (P14), a characteristic point of the present apparatus, described later.

The present example is premised on the prescan-less ACS determination. With a prescan ACS determination, it is possible to use the compressing section 1002 to store the final determination result together with the block unit ACS determination result and the result for the mode signal 1019 in the page memory 1004 before storing the first compressed data 1012. In this case, for single copying, decoding/printing can be accomplished simultaneously with scanning without the need for storage in the page memory 1004. This improves performance.

This description is premised on the entire ACS 1003. However, with, for example, a color printer engine based on a four-rotation system, printing may be started with a K plane, which may be processed in accordance with the determination result from the block ACS 1018. Then, simultaneously with this process, the block ACS determination result is counted. Then, if pixels determined to be colored through the block ACS after the K plane printing process have a predetermined value or smaller, the document is determined to be monochromatic. Thus, the printing is finished only with the monochromatic process and without printing for C, M, and Y plates. This eliminates the need for the entire ACS process of a full image plane to improve the performance.

Furthermore, with a printer engine based on a tandem system, it is difficult to achieve printing by rotating only a drum with a K plane (because data requiring the C, M, or Y plate may occur during main scanning). However, it is possible to obtain an image corresponding only to the K plane while improving the performance as in the case of the four-rotation system.

Furthermore, the block unit ACS determination involves a smaller amount of information available for the determination than the entire ACS determination. The block unit ACS determination is thus susceptible to noise and may produce results different from those of the entire ACS determination. Thus, the measures described below may be taken.
1) The compression block size is increased.
2) A determination result for an area larger than the compression size is inserted into each compressed block.
3) A line ACS determination is calculated from the result of the block ACS determination.

The measures 1) and 2) make it likely that the individual compressed blocks are determined to be colored. Furthermore, the data reducing effect produced by the first code converting section may be degraded. On the other hand, the measure 3) can produce a determination result for each line while maintaining the efficiency. Accordingly, with the above tandem system, it is possible to accomplish printing by rotating only the K plane drum. In this case, the line ACS determination results, a memory retaining the compressed data 1012 for each line is required. However, the compression of data may serve to give advantages such as improved performance even with the additional cost of the memory. This corresponds to a point (P15), a characteristic point of the present apparatus described later.

As an alternative to implement the block ACS, the first code converting section 1008 may execute determinations on the basis of the contents of the compressed data 1012. In this case, the ACS determination for the first compressed data 1012 can be easily executed by, for example, checking a match to the ROM data CbCr=0, provided by the code changing section 1005-2 (shown in FIG. 8). This corresponds to a point (P13), a characteristic point of the present apparatus described later.

FIG. 11 shows an example of the lookup table 1020. FIG. 11 shows a pattern in which the determination result produced by the entire ACS is 0, while the determination result produced by the block ACS is 1. This is because with scanner inputs, the system shown in FIG. 4 may result in a difference in determination result between the block unit and the entire image unit.

Instead of neglecting such a possible block mismatch and forcedly zeroing the Cb and Cr components as in the present example, the block may be decoded and the Y component corrected using the non-zero Cb and Cr components, to obtain an image of higher quality.

FIG. 11 shows that if the entire-image ACS determination result is 1 and the block ACS determination result is 0, the total determination result is 0. This is because part of the entire area of the document may be monochromatic. For example, a red marker may be used to draw lines on a monochromatic document.

Moreover, the present example is premised on an accurate entire ACS determination and a less accurate block ACS determination. However, a configuration may be employed which references a plurality of block ACS determination results to correct the entire ACS determination result, thus improving the accuracy of the entire ACS determination result. For example, different pixel unit determination thresholds may be used for the block unit ACS determination and for the entire ACS determination so that the block ACS is more likely to determine that the block is colored. Then, when the entire ACS determination result indicates that the image is monochromatic and if the areas determined by the block ACS to be colored have a certain regularity, the entire ACS determination is corrected so as to indicates that the image is colored. This is because the setting of a threshold and the like for the entire ACS determination are generally carried out taking noise from the input system into account but because for some images, it is difficult to determine whether a very small area of the image corresponds to noise or a significant image. This corresponds to a point (P14), a characteristic point of the present apparatus described later.

In the present example, the JPEG is used as a compressing technique. However, the present invention is not limited to this technique. It is possible to use any technique to execute a sequence conversion of a frequency or the like for each block and then carry out entropy coding such as Huffman coding.

Furthermore, in the illustrated configuration, the compression is carried out only by the compressing section 1002. The subsequent reduction of the amount of data is carried out by the first code converting section 1008. However, another compressing method may be used to execute compression after the first code conversion.

Moreover, in the present example, the R, G, and B image signals are used. However, similar effects may be produced by using the same concept for a C, M, Y, and K image signals. Furthermore, in the present example, the fixed length data 1012 is created by setting a fixed code amount for each color plate. However, the method of setting a fixed length is not limited to this. For example, the effects of the present invention are expected to be produced by generating fixed length data from the entire block (in the present example, the total fixed length of the Y, Cb, and Cr components is 40 bytes). Furthermore, the conversion of the fixed length/variable length, the ACS system, the document mode, and the like are not limited to those in the present example.

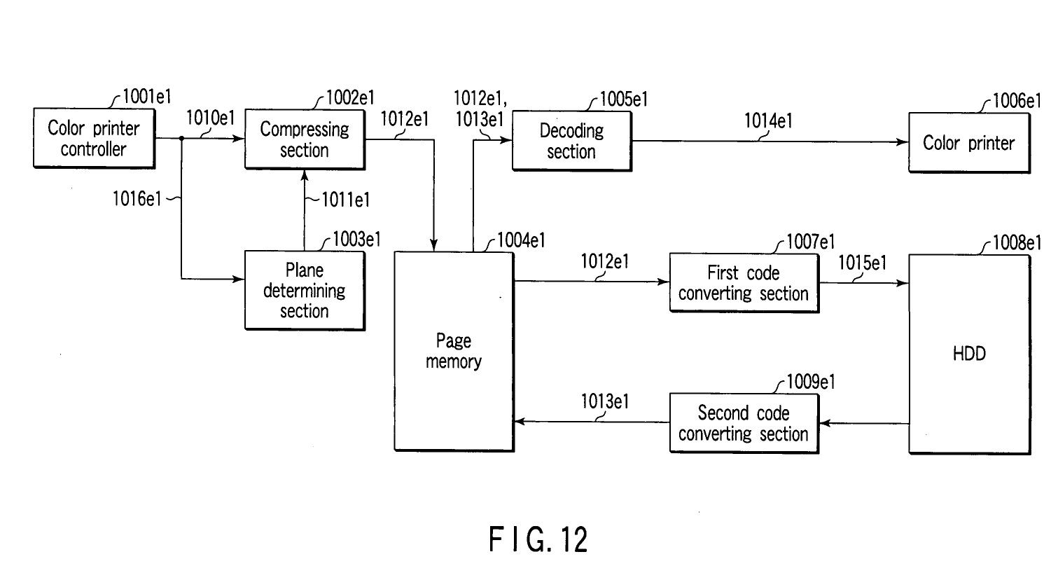

FIG. 12 shows a first variation of the first embodiment. A color printer controller 1001e1 provides an image signal 1010e1. This image signal is for C, M, Y, and K. A plane determining section 1003e1 is used to determine whether the image is colored or monochromatic. A compressing section 1002e1, a page memory 1004e1, a decoding section 1005e1, a color printer 1006e1, a first code converting section 1007e1, a hard disk device 1008e1, and a second code converting section 1009e1 are the same as the compressing section 1002, page memory 1004, decoding section 1005, color printer 1006, first code converting section 1007, hard disk device 1008, and second code converting section 1009, shown in FIG. 1.

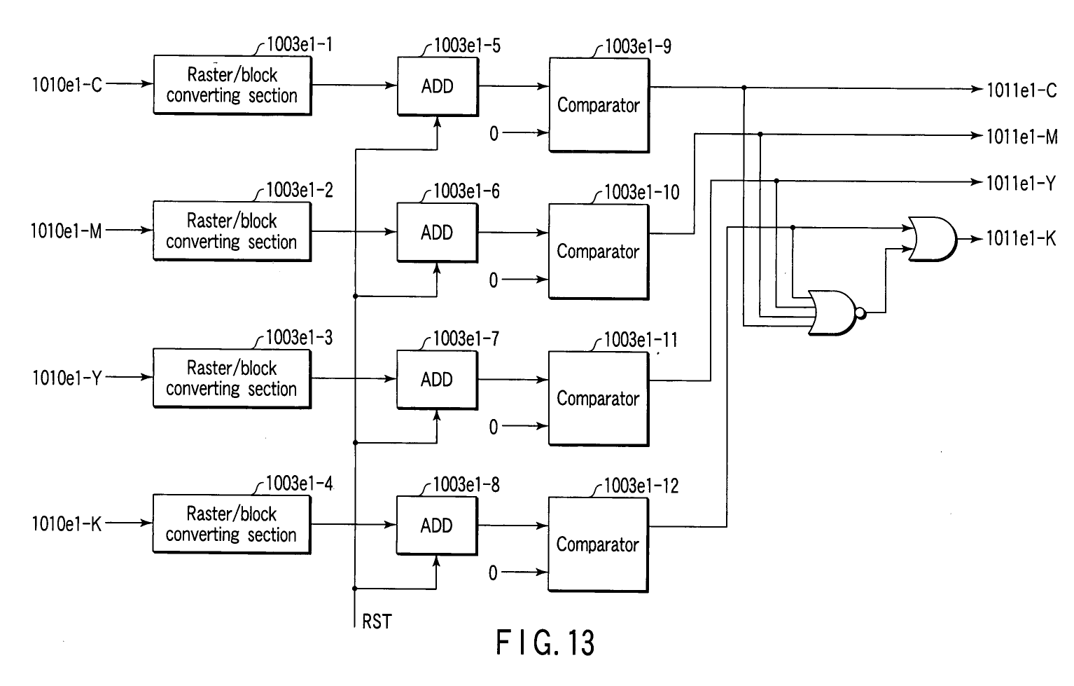

FIG. 13 shows an example of the configuration of the plane determining section 1003e1. Input image signals include C (a cyan signal), M (a magenta signal), Y (a yellow signal), and K (a black signal). The signals 1010e1-C, 1010e1-M, 1010e1-Y, and 1010e1-K are inputted to the corresponding raster/block converting sections 1003e1-1, 1003e1-2, 1003e1-3, and 1003e1-4. The signals are thus converted into blocks. The blocks are inputted to the corresponding adders 1003e1-5, 1003e1-6, 1003e1-7, and 1003e1-8. Each of the adders adds up a plurality of blocks so as to obtain compressed block units. The results of the addition in compressed blocks are inputted to the corresponding comparators 1003e1-9, 1003e1-10, 1003e1-11, and 1003e1-12. Subsequently, the adders 1003e1-5, 1003e1-6, 1003e1-7, and 1003e1-8 are reset. Each of the comparators 1003e1-9, 1003e1-10, 1003e1-11, and 1003e1-12 compares the addition results with “0” and outputs 0 if they are equal, while outputting 1 if they are not equal. Thus, a plane determination signal 1011e1 is outputted. Specifically, the output indicates, for each plane of a compressed block unit, whether or not the block is 0. In the present example, the 4 bits of the plane determination signal 1011e1 correspond to the C, M, Y, and K signals, respectively, from the most to least significant bits. However, if the entire plane is 0 (blank sheet), the output indicates that there is data for the K plane. A NOR circuit or an OR circuit is used for this purpose.

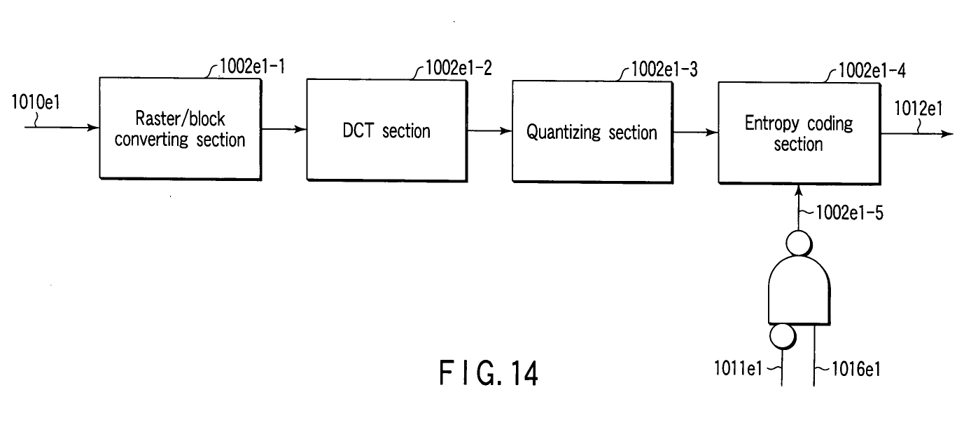

FIG. 14 shows an example of the configuration of the compressing section 1002e1, shown in FIG. 12. This configuration is essentially similar to the one shown in FIG. 2 except that it lacks the RGB/YIQ converting section, provided in the example in FIG. 2, that a path select signal 1016e1 and a plane determination result 1011e1 are inputted to a control terminal of the entropy coding section 1002e1-4 via the NOR circuit, and that the color determination area is composed of 4 bits (the signal 1011e1 is composed of 4 bits) instead of 1 bit.

The path select signal 1016e1 indicates whether or not the compressed data is used for single printing (=0) or for electronic sorting (=1). If the compressed data is used for single printing, all the 4 bits of a control signal 1002e1-5 are 1. If the compressed data is used for electronic sorting, the signal 1011e1 directly becomes the control signal 1002e1-5.

The present configuration enables the switching between a colored image and a monochromatic image (only K or the other colors). And it enables the removal of blocks of the color plates which is not used; for example, information on only cyan or only cya+magenta among the four color plates. This enhances the reducing effect.

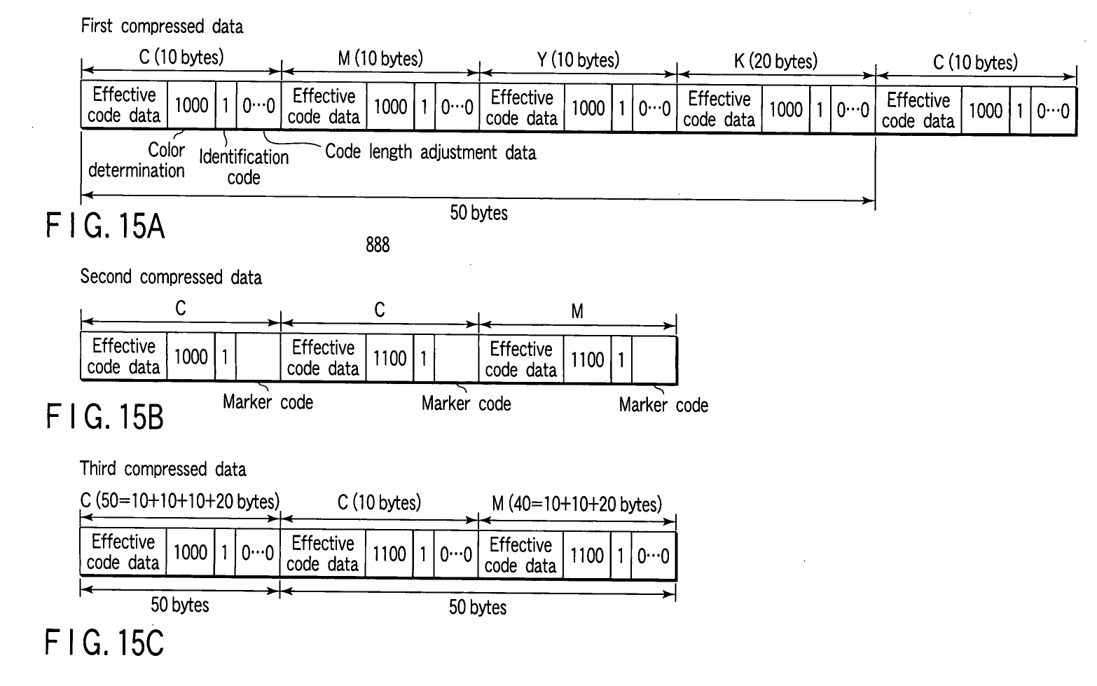

FIGS. 15A to 15C show examples of reduction. This example produces a higher reducing effect than the first embodiment, which reduces the amount of data by the switching between a colored image and a monochromatic image. It is assumed that the data in FIG. 15A indicates C, M, Y, K, C, . . . . It is further assumed that the result of a plane determination indicates that the first group of C, M, Y, K contains only cyan C. Then, as shown in FIG. 15B, the M, Y, and K components are removed from the first group, with only the C component left. FIG. 15C shows that a restoring operation has been performed. Adjustment data is added to the C component of the first group. This corresponds to a point (P16), a characteristic point of the present apparatus described later.

The white blocks are processed as the monochromatic image by the above embodiments. However, it is possible to reduce the white blocks by improving the coding and decoding method, and obtain a compressing efficiency. This correspond to a point (P17), a characteristic point of the present apparatus described later.

Specifically, in the present example, the format of Huffman code+color determination+identification code+code length adjustment (marker code) is used to search the former half (Huffman code) and latter half (fixed length and marker code) of codes for a code boundary based on the fixed length of the data and the specificity of the marker code. However, with a format in which code length information+color determination is added to the leading end of the Huffman code, a search for the code boundary can be accomplished for each block even if there is not any color plate data (there is not any Huffman code) as in the case of a white block. As a result, the amount of data in white blocks can be removed.

Determination information can be more freely generated by additionally producing an ACS determination result indicating that the image is colored if the information on the C, M, and Y plates is not 0 and is monochromatic if the information is 0. This corresponds to a point (P9), a characteristic point of the present apparatus described later.

Moreover, the determination results for the respective blocks can be integrated together to allow the execution of an ACS determination for the entire image or blank sheet determination. For example, a circuit may be added which latches data of 1 (indicating a colored image or a non-blank sheet; no operation is performed if the data is 0) outputted as a result of a block ACS determination or a blank sheet determination. Then, by obtaining an output from the circuit when the entire image has been processed, it is possible to obtain the results of the entire ACS determination and the blank sheet determination. This corresponds to a point (P18), a characteristic point of the present apparatus described later.

Moreover, when the document is colored, the color printer controller 1001e1 generally outputs CMYK data. However, when the document is monochromatic, the color printer controller 1001e1 may output only K data without processing the other color plates in order to increase an operating speed. In this case, if the compressing section 1002e1 executes a compressing process on the basis of CMYK data by considering the K plane data to be CMY=0, then the degradation of image quality can be equally reduced for a monochromatic area in a colored document and for a monochromatic document. Moreover, with the present configuration, the first code converting section 1007e1 can reduce extra color information accompanying the process for CMY=0. This suppresses an increase in the amount of codes resulting from the process for CMY=0. Furthermore, the arrangement forcedly converting monochromatic data into colored data to maintain a fixed image quality is of course applicable to Embodiment 1. For example, even if a monochromatic signal is used for a scanner to which a colored signal and a monochromatic signal can be selectively inputted, similar effects are expected to be produced by converting the signal into a colored format. This corresponds to a point (P19), a characteristic point of the present apparatus described later. The effects of the use of a monochromatic signal generated by a color scanner have already been described in Embodiment 1.

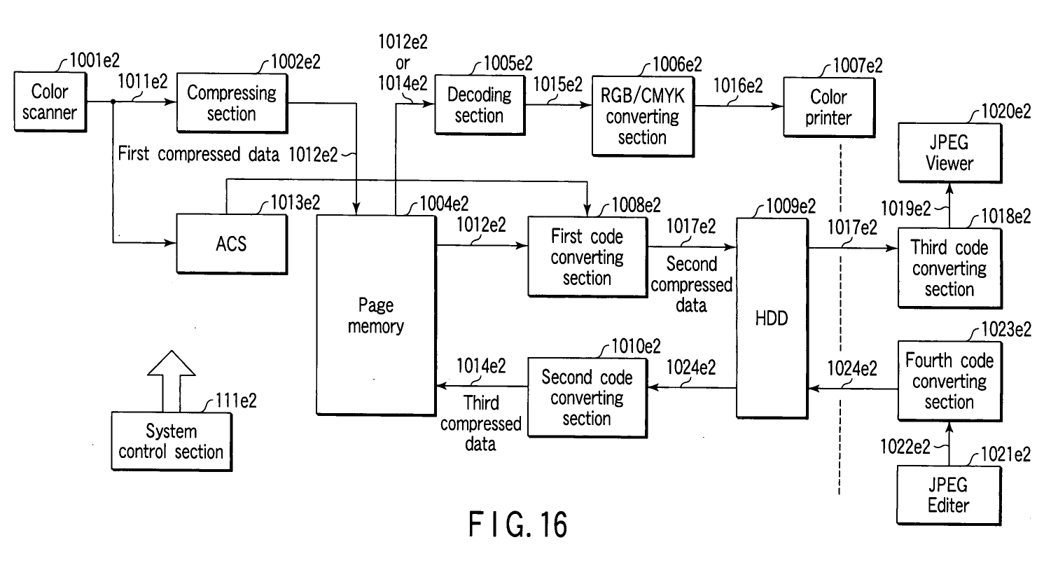

FIG. 16 shows yet another embodiment corresponding to a second variation of the first embodiment.

Second compressed data 1017e2 can be taken out of a hard disk device 1009e2. A third code converting section 1018e2 can convert the second compressed data 1017e2 into fourth compressed data 1019e2 and supply the fourth compressed data 1019e2 to a JPEG Viewer 1020e2. A fourth code converting section 1023e2 then converts an output 1022e2 from the JPEG Editor 1021e2 into fifth compressed data 1024e2. The fourth code converting section 1023e2 then stores the fifth compressed data 1024e2 in the hard disk device 1009e2. A second code converting section 1010e2 can output the second compressed data 1017e2 or fifth compressed data 1024e2 as third compressed data 1014e2.

The third code converting section 1018e2 removes the color determination, the identification code, and the marker code. Then, if the entire ACS determination result is “1” (color), then for each block for which the block color determination result is “0”, the third code converting section 1018e2 adds the code information CbCr=0 to the output 1017e2 similarly to the decoding section 1005 in Embodiment 1. The third code converting section 1018e2 thus considers the output 1017e2 to be a colored file. The third code converting section 1018e2 then adds JPEG header information to the output 1017e2 to the convert it into the fourth compressed data 1019e2. This corresponds to a point (P20), a characteristic point of the present apparatus, described later.

If the entire ACS determination result is “0”, indicating a monochromatic image, the first code converting section 1008e2 removes all of the Cb and Cr information, leaving only the Y code. Consequently, the third code converting section 1018e2 considers the output 1017e2 to be a monochromatic file. The third code converting section 1018e2 then adds JPEG header information to the output 1017e2 to the convert it into the fourth compressed data 1019e2.

By removal of the header information and the addition of a color determination, an identification code, and a marker code, the fourth code converting section 1023e2 converts the standard JPEG code 1022e2 into the fifth compressed data 1024e2. This corresponds to a point (P21), a characteristic point of the present apparatus, described later.

For the color determination, the standard JPEG code 1022e2 is 1 for a colored image or 0 for a monochromatic image; the coding is carried out in accordance with a rule similar to the one used in Embodiment 1. The fourth code converting section 1023e2 can also accomplish a color determination by analyzing the header of the JPEG code without executing a color/monochromaticity determination. In this case, the color determination is based only on the result of the entire ACS determination. Consequently, monochromatic areas in a colored document are considered to be colored.

The compressed data 1017e2 and 1024e2 can be coded in exactly the same format. Accordingly, the second code converting section 1010e2 need not switch between the compressed data 1017e2 and the compressed data 1024e2. Further, the compressed data 1017e2 and 1024e2 can be mixed with code data obtained by applying the block ACS to the compressed data 1012e2 as described in FIG. 10. Furthermore, the fifth compressed data 1024e2 can further be reduced by using the fourth code converting section 1023e2 to execute a block ACS determination.

The block ACS determination can also be utilized for the third code converting section 1018e2 as described below. When the JPEG Viewer 1018e2 instructs on the loading of an image present at specified coordinates instead of the entire image, ACS determination information for the specified area can be generated from the block ACS determination information for the specified area. Thus, even if the entire ACS determination result indicates that the entire image is colored, the data can be converted into a monochromatic file for output provided that the specified area is determined to be monochromatic. This corresponds to a point (Pl1), a characteristic point of the present apparatus, described later.

The present configuration enables easy linkage not only with the interior of an image forming apparatus (MFP) but also with external applications such as JPEG Viewer. This makes it possible to efficiently reduce the amount of data stored in the HDD, for which there are demanding requests for a reduction in the amount of codes.

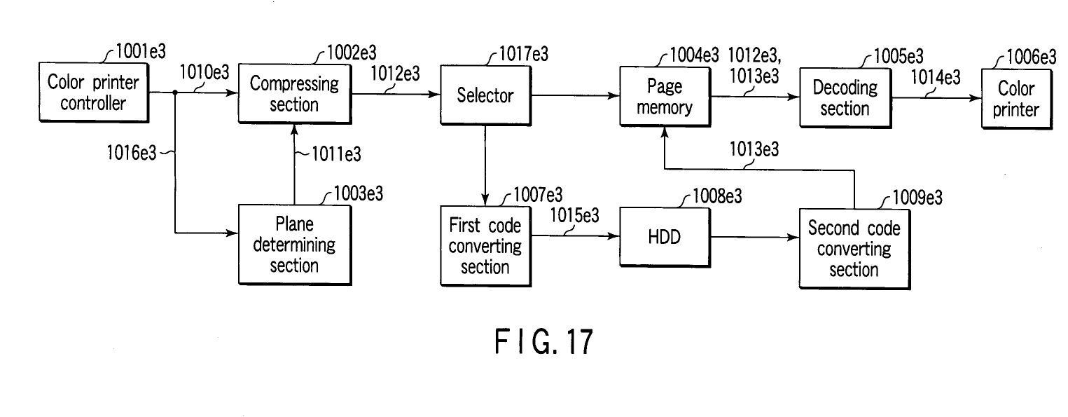

FIG. 17 shows further another embodiment corresponding to a third variation of the first embodiment.

This variation is similar to the first variation of the first embodiment except that a selector 1017e3 is added which selects whether to transmit the first compressed data 1012e3 to the page memory 1004e3 or directly to the first code converting section 1007e3.

With the present configuration, if a long time is required to create RIP data as in the case of multipage printing, the data is stored directly in the hard disk without using the page memory. Accordingly, if for example, this configuration is combined with the arrangement of the color scanner in Embodiment 1, the page memory can be used by the copying side and the printer side without any competitions. This serves to improve the performance. This corresponds to points (P22) and (P23), characteristic points of the present apparatus, described later.

In the present example, the compressing section and the first code converting section have been separately described. However, of course, the effects of the present invention are not affected even if the compressing section incorporates the first code converting section and selects an operation to perform.

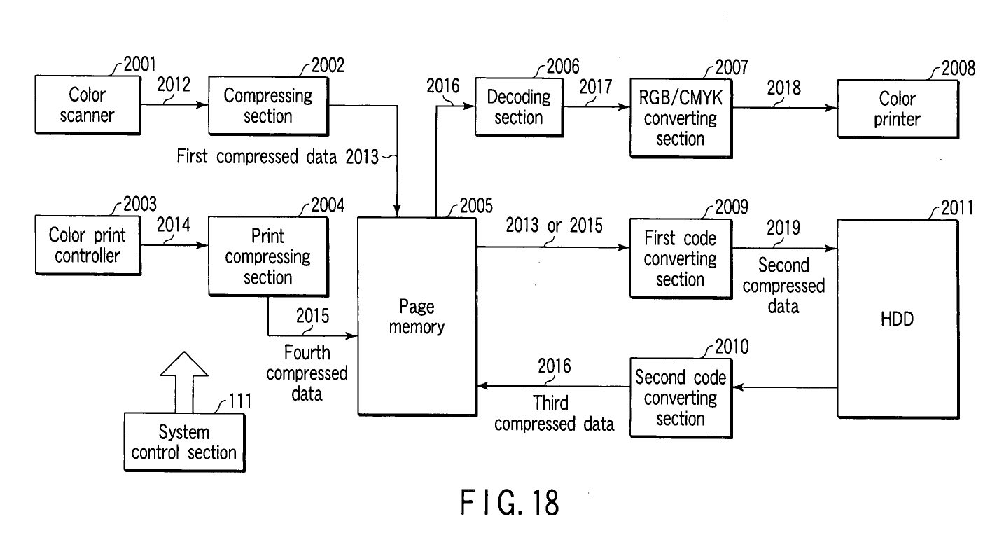

FIG. 18 shows still another embodiment. This embodiment is essentially similar to the embodiment in FIG. 1 and the example in FIG. 12 except that it lacks the color determining section.

An RGB signal 2012 is outputted by a color scanner 2001. A scan compressing section 2002 then compresses the RGB signal 2012 into first compressed data 2013 and stores the data 2013 in a page memory 2005. Likewise, a print compressing section 2004 compresses a CMYK signal 2014 from a color printer controller 2003 into second compressed data 2015. The print compressing section 2004 then stores the second compressed data 2015 in the page memory 2005.

The first code converting section 2009 selectively processes and converts the first compressed data 2013 and the second compressed data 2015 into third compressed data 2017. The first code converting section 2009 stores the third compressed data 2017 in a hard disk device 2011. If only the first compressed data 2013 or the second compressed data 2015 is printed, a second code converting section 2010 converts the compressed data read from the hard disk. A decoding section 2006 then decodes the resulting data. When the decoded data is from the color scanner and is to be printed, it is printed after passing through an RGB/CMYK converting section 2007. A control signal (from the system control section 111) switches the operation among the first code converting section 2009, the second code converting section 2010, the decoding section 2006, and the RGB/CMYK converting section 2007. This corresponds to a point (P24), a characteristic point of the present apparatus, described later.

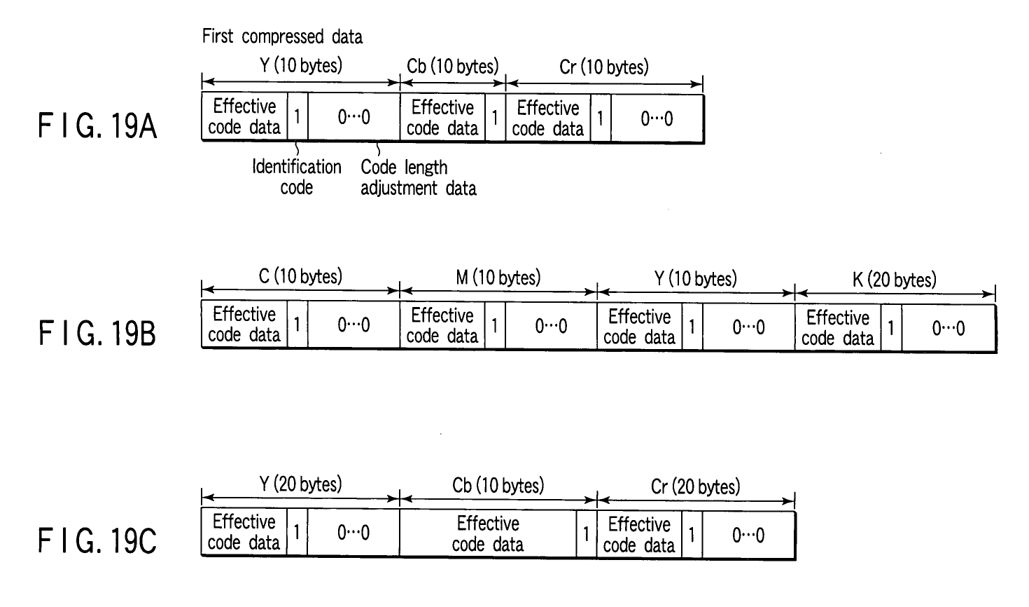

Now, with reference to FIGS. 19A to 19C, description will be given of an operation performed if a mixture of the first compressed data 2013 and the second compressed data 2015 is printed in the same page. FIG. 19A shows a format used if only the first compressed data 2013 is printed. FIG. 19B shows a format used if only the second compressed data 2015 is printed. FIG. 19C shows a format for the first compressed data 2013 used if the mixture of the first compressed data 2013 and the second compressed data 2015 is printed.

Specifically, when a mixture of compressed data in different formats is printed, print data is obtained by using the longest code format as a reference to adjust the other format lengths to this format. This corresponds to a point (P26), a characteristic point of the present apparatus, described later.

The block unit of the format in FIG. 19A is 40 bytes, and the block unit of the format in FIG. 19B is 50 bytes. Consequently, the block unit of the format in FIG. 19C is 50 bytes. In accordance with a control signal (not shown), the decoding section 2006 and the RGB/CMYK converting section 2007 switch their processing upon receiving a block of the page in the format shown in FIG. 19B or 19C, from the page memory. In this connection, the design of a mixing location and the like are managed by a CPU (not shown) that instructs on mixed printing. It is easy to instruct on a switching location or the like because the corresponding address calculation is easy. The present example shows the configuration in which the format is adjusted for mixed printing. However, even for non-mixed printing, by adjusting the format using the maximum possible code length for mixed printing, it is possible to easily execute an address calculation at the expense of the use efficiency of the memory.

The present configuration enables different functions to be combined together for outputs to the printer section, for which data is desirably read at a fixed high rate. It also enables editions such as rotation to be easily accomplished.

It is also possible to use a configuration for color determination or a configuration in which the page memory 2005 can output not only a compressed signal 2016 but also the compressed signals 2013 and 2015, as in the case of the embodiments shown in FIGS. 1 and 3. In the present example, description has been given of the configuration in which copying and printing are simultaneously executed on one sheet. However, it is needless to say that the present embodiment can essentially be combined with any of a scanner, a copier, a printer, and external equipment as in the embodiment shown in FIG. 16.

Furthermore, in the present example, after the compressed data has been stored in the hard disk, the second code converting section 2010 adjusts the code length of the compressed data for copying or for the printer. However, if the compressed data is to be printed by being expanded directly into the page memory without using the hard disk, the scan compressing section 2002 and the print compressing section 2004 may similarly adjust the code length.

Moreover, the present example uses the common compressing method. However, a variable combination of compressing methods can be used provided that the rules for the second code converting section 2010 and page memory are observed. However, if rotation or the like is to be carried out, a rotating or printing process can be executed at a higher speed by using a fixed compressing process unit and a fixed resolution as in the case of the present embodiment or converting the compressing process unit and resolution to fixed values anywhere before the data is read from the page memory.

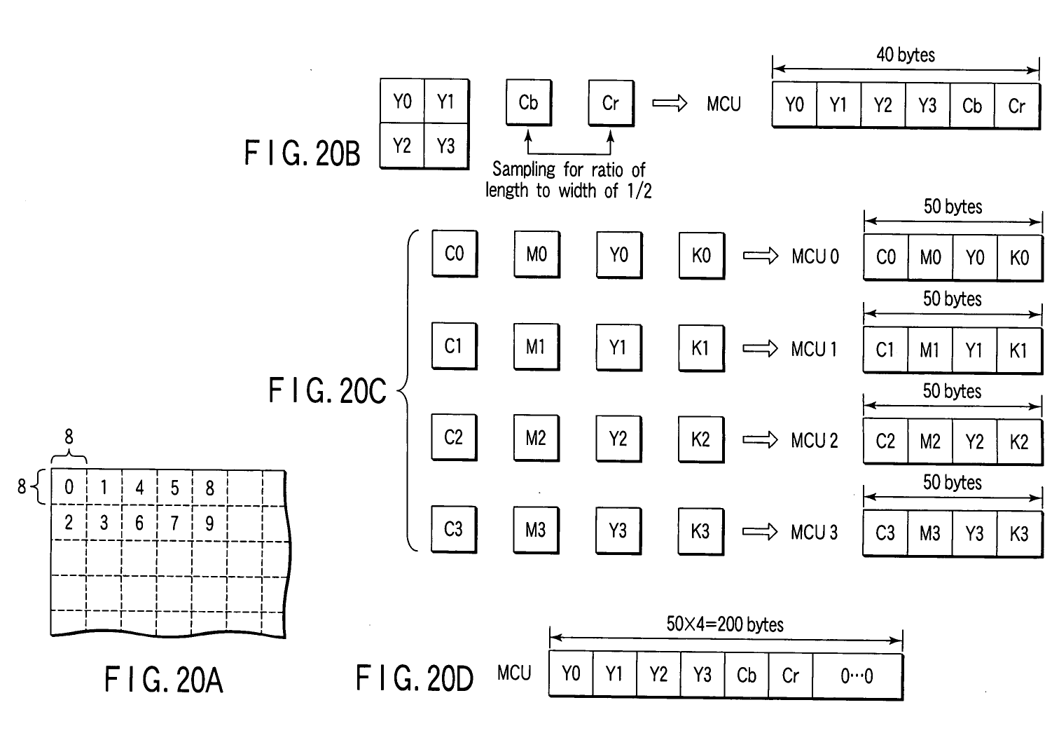

For example, the processing unit may vary even if the resolution and the block unit are fixed as shown in FIGS. 20A to 20D. Thus, fixing the processing unit enables rotation and printing to be easily carried out (MCU is a processing unit for JPEG).

FIG. 20B shows an example of the compressed signal 2013. In this example, 16×16 pixels, divided into blocks of 8×8 pixels, are extracted from the image area shown in FIG. 20A. For each of Cb and Cr, one block composed of 8×8 pixels is obtained through sub-sampling.

To allow the same access unit to be used on the page memory, the compressed signal 2015 shown in FIG. 20C must be similarly handled using the 16×16 unit. Accordingly, four MCU units are used as one unit. Thus, the code length of one unit is 40 bytes in FIGS. 20B and 50×4=200 bytes in FIG. 20C. Consequently, the second code converting section 2010 may adjust the codes shown in FIG. 20B to 200 bytes as shown in FIG. 20D and then store the adjusted data in the page memory.

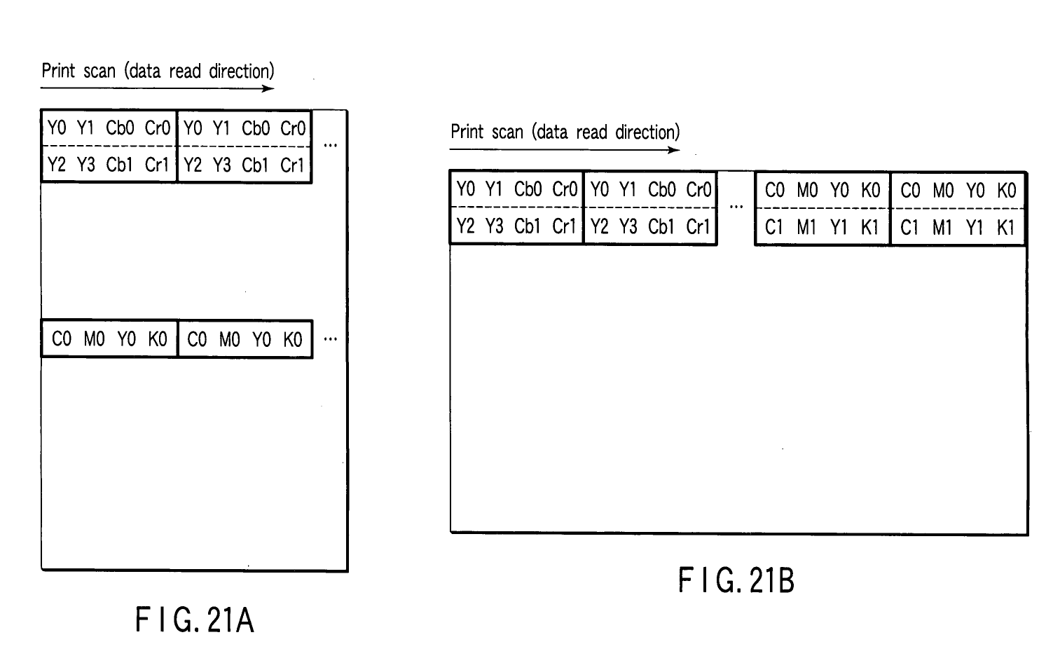

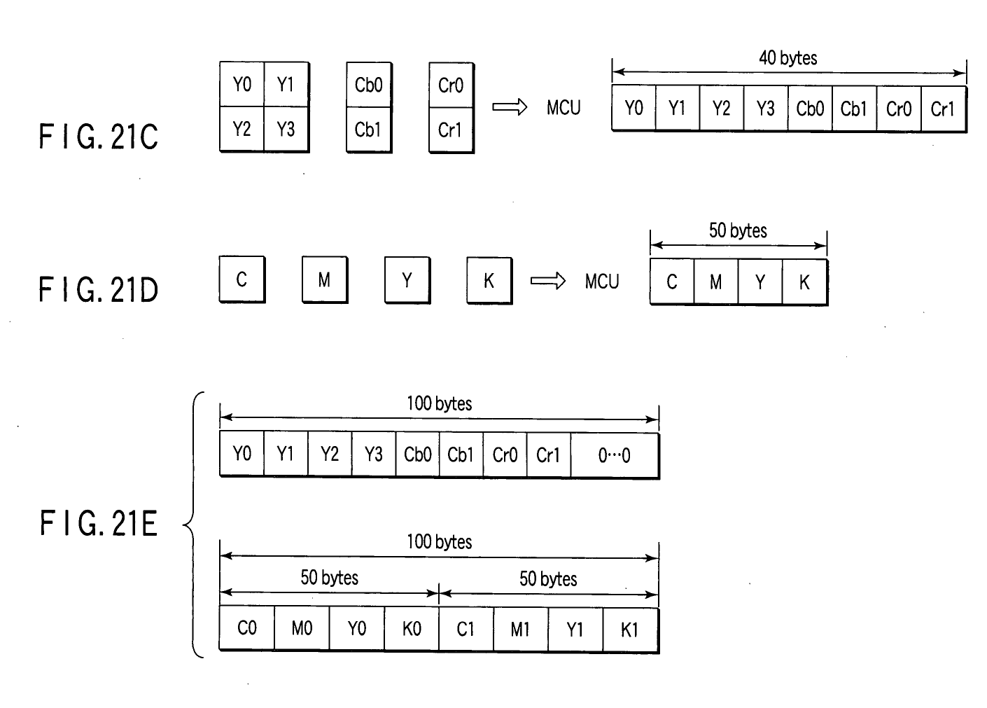

Further, if the relationship between the data and the direction of printing is known as shown in FIGS. 21A and 21B, the resolution, processing unit, and code length need not necessarily be fixed, though the process may be slightly complicated. FIG. 21A shows an example in which an image based on a YCbCr image signal is printed in the upper stage of a sheet, whereas an image based on a CMYK image signal is printed in the lower stage of a sheet. However, a common resolution is desirably used for the image based on the YCbCr image signal and for the image based on the CMYK image signal. In this example, the common resolution is used.

With the print design shown in FIG. 21A, a sub-scanning resolution and a sub-scanning processing unit remain unchanged in a main scanning direction for printing. Accordingly, the address calculation for the memory and the like can be executed without any conversions. For example, for the YCbCr blocks, the address calculation can be started from the upper left (address 0) on the basis of the (number of blocks to be processed×YCbCr fixed length size).

For the CMYK blocks, the address calculation can be executed by adding the (number of CMYK blocks to be processed×CMYK fixed length size) to the (YCbCr fixed length size×total number of YCbCr blocks) for the upper left of CMYK.

For the print design shown in FIG. 21B, it is difficult to switch the processing when the data read sub-scanning direction is switched (to the main scanning direction). Accordingly, the resolution and processing unit in the sub-scanning direction are adjusted. Specifically, as shown in the upper stage in FIG. 21E, code adjustment is executed on the 40-byte YCbCr image signal arranged in the order of Y0 to Y3, Cb0, Cb1, Cr0, and Cr1, to convert the signal into 100 bytes. Furthermore, as shown in the lower stage in FIG. 21E, the CMYK image signal is arranged in the order of C0, M0, Y0, K0, C1, M1, Y1, and K1 and thus converted into 100 bytes.

Provided that the data can be loaded into the page memory using the arrangement shown in FIG. 21B, the block code length of the YCbCr image signal need not necessarily be made equal to block code length of the CMYK image signal. This corresponds to a point (P25), a characteristic point of the present apparatus, described later.

For example, the start coordinates of the third sub-scanning block of the CMYK signal can be calculated as follows:
the number of main scanning blocks in the YCbCr signal×YCbCr fixed length size×3+the number of main scanning blocks in the CMYK signal×CMYK fixed length size×2.

Furthermore, in the present example, the mixed data is shown as a colored signal. However, on the basis of a similar concept, monochromatic images may be mixed together or a colored image may be mixed with a monochromatic image.

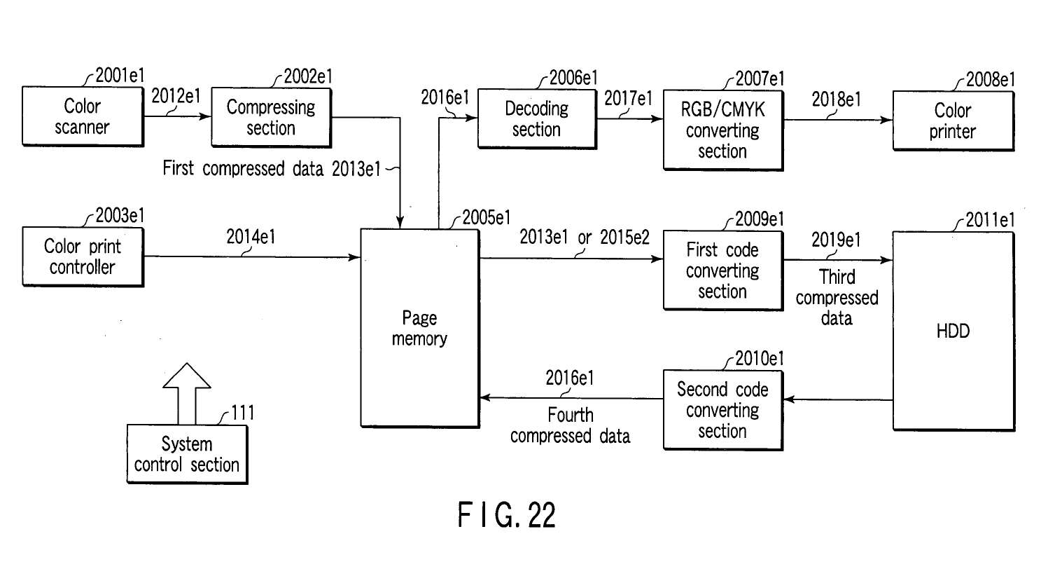

FIG. 22 shows still another embodiment of the present invention corresponding to a first variation of the embodiment shown in FIG. 18. This embodiment is essentially similar to the embodiment shown in FIG. 18 except that it lacks the print compressing section.

A color print controller 2003e1 outputs binary CMYK data 2014e1. When image data of compressed data 2013e1 is independently printed, a process similar to the one shown in FIG. 18 is executed. When image data of compressed data 2014e1 is independently printed, it is printed by a color printer 2008e1 after passing though a first code converting section 2009e1, a second code converting section 2010e1, a decoding section 2006e1, and an RGB/CMYK converting section 2007e1.

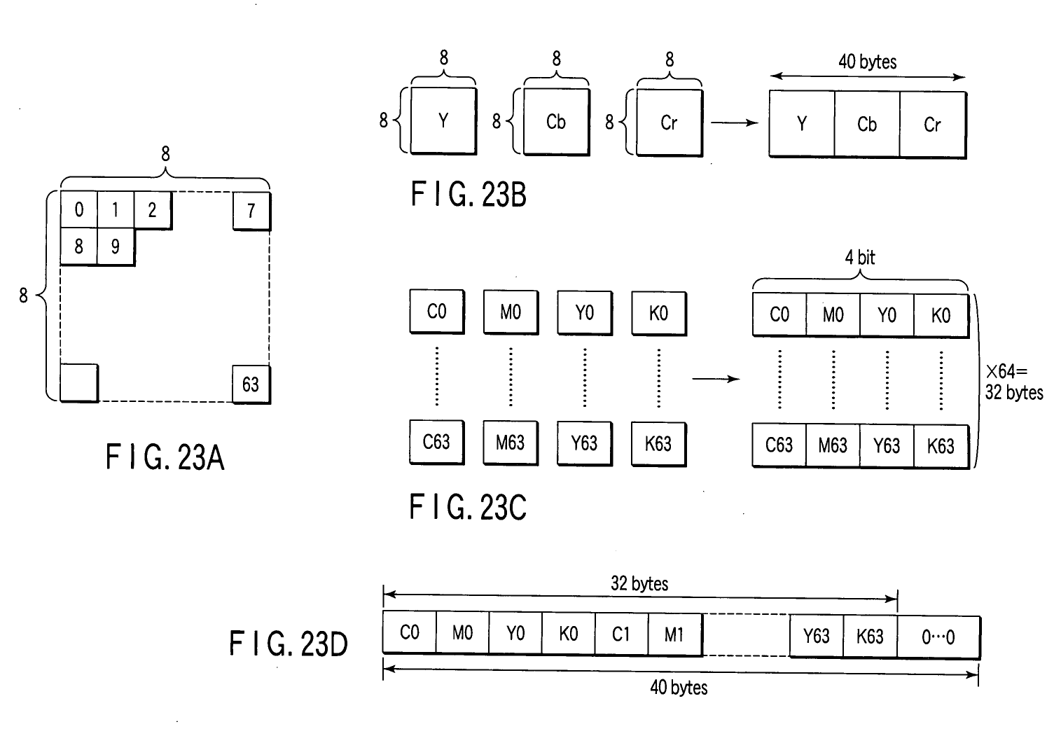

For mixed data, the second code converting section 2010e1 executes a converting process such as the one shown in FIGS. 23A to 23D. Specifically, compressed data 2014e1 (FIG. 23C) is arranged in accordance with the 8×8 processing unit of data 2013e1 (FIG. 23A), with its code length properly adjusted. The compressed data 2014e1 is thus converted into the data shown in FIG. 23D. The resultant data is then transferred to the page memory. This corresponds to a point (P27), a characteristic point of the present apparatus, described later.

When the converted compressed data 2014e1 is transferred to the decoding section 2006e1, the decoding section 2006e1 outputs decoded data having the same line arrangement as that of the compressed data 2013e1. The RGB/CMYK converting section 2007e1 may pass through the data which is converted the compressed data 2014e1 because the data is arranged in lines.

In the present example, the binary data is stored in the hard disk without being compressed. However, the amount of data stored in the hard disk can be reduced by using the first code converting section to compress the data and using the second code converting section to decode the data and adjust its code length. Other data formats can be similarly implemented, such as multi-valued data other than binary data or a combination of colored and monochromatic data.

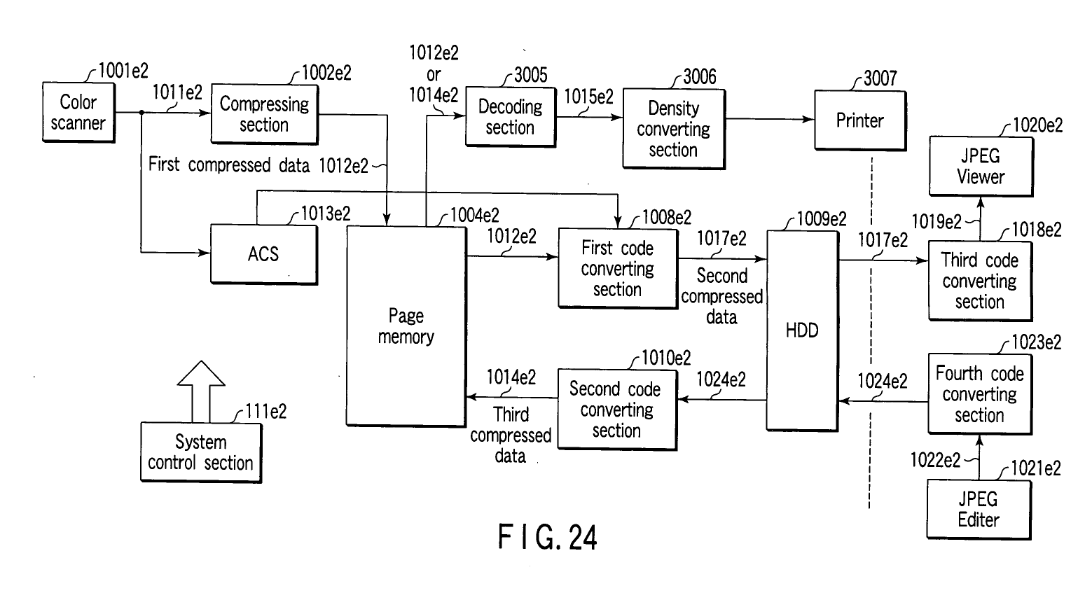

FIG. 24 shows further another embodiment of the present invention. This embodiment is essentially similar to the embodiment shown in FIG. 16 except that a decoding section 3005 decodes only monochromatic data, that a print signal is generated using a density converting section 3006 in place of the RGB/CMYK converting section, and that a monochromatic printer 3007 is used for printing in place of the color printer.

If the second compressed data 1017e2 and the fifth compressed data 1024e2 are colored compressed data, the second code converting section 1010 cuts the Cb and Cr components to forcedly covert the data into a monochromatic format. This corresponds to points (P28) and (P29), characteristic points of the present apparatus, described later.

With the present configuration, a mixture of the colored format and the monochromatic format is present in the hard disk device 1009e2. Accordingly, if either the colored data or monochromatic data is to be utilized as scan data, it can be independently extracted.

Further, images determined to be monochromatic as a result of an ACS determination are stored in the hard disk device 1009e2 as monochromatic compressed data with color components cut. Accordingly, the data is efficiently reduced. In addition, the second code converting section forcedly converts the data into the monochromatic format. Consequently, all the data including external compressed data and color compressed data read from the hard disk device can be equally handled as monochromatic images to be printed. Moreover, for printing, the page memory has only to have a monochromatic size. This makes it possible to reduce the required size of the memory.

Additionally, by providing a process of allowing the second code converting section to forcedly convert data into the color compressed data format and allowing a decoding section 3005 to convert a colored image into a monochromatic one, it is possible to use the monochromatic printer to print a mixture of data read by the color scanner and then stored in the page memory 1004e2 and data read from the hard disk device 1009e2. This corresponds to a point (P30), a characteristic point of the present apparatus, described later.

A detailed description will be given of the characteristic points of the above apparatus and method for image processing according to the present invention. According to the present invention, (P1) the apparatus for image processing essentially has the first compressing section 1002 which compresses each block of an image into the first compressed data 1012, the first code converting section 1008 which converts the first compressed data 1012 into the second compressed data 1017, the second code converting section 1010 which converts the second compressed data 1017 into the third compressed data 1014, and the decoding section 1005 which decodes the third compressed data 1014.

In this case, the second compressed data 1017 is obtained by converting the first compressed data 1012 so that each block of the second compressed data 1017 has a code length equal to or different from that of each block of the first compressed data 1012. Each block of the third compressed data 1014 has a code length equal to that of each block of the first compressed data. Thus, the first code converting section reduces the amount of data. Therefor, in the HDD or network for which the amount of data is desirably minimized, the data amount is reduced. Furthermore, the third compressed data length has a fixed value. This enables an address calculation or the like to be easily executed for editing functions such as rotation.

(P2) In addition to the above basic configuration, in the apparatus according to the present invention, the decoding section 1005 decodes the first compressed data 1012 or the third compressed data 1014. This makes it possible to decode coded data of the type passed to the HDD or network and coded data used without using the HDD or the like. Therefore, a signal path can be more freely used.

(P3) In addition to the above basic configuration, in the apparatus according to the present invention, the ACD 1003 is provided as a color determining section to determine whether the image is colored or monochromatic. Accordingly, codes are converted in accordance with the results of ACS determinations. This enables the amount of data is efficiently reduced in the HDD or network etc. Furthermore, the third compressed data length has the fixed value. This enables the address calculation to be easily executed for the editing functions such as rotation regardless of the color type of the document.

(P4) In addition to the above basic configuration, the apparatus according to the present invention is characterized in that each block of the third compressed data has the same code length and format as those of each block of the first compressed data. Accordingly, a reduction in data makes it possible to reduce the amount of data in the HDD or network, for which the amount of data is desirably minimized. Furthermore, the first and third compressed data have the same code format and can thus be similarly decoded during decoding.

(P5) In addition to the above basic configuration, in the apparatus according to the present invention, the second compressed data is obtained by converting the first compressed data so that each block of the second compressed data has a code length equal to or different from that of each block of the first compressed data. The third compressed data has a code length equal to the first compressed data. If the third compressed data has a code format different from that of the first compressed data, the decoding section 1005 decodes the third compressed data by converting it into the code format of the first compressed data. Accordingly, a reduction in data makes it possible to reduce the amount of data in the HDD or network, for which the amount of data is desirably minimized. Furthermore, the first and third compressed data have the same code format and can thus be similarly decoded during decoding. The code format is adjusted during decoding, thus allowing data to be more freely dispatched to the decoding section.

(P6) In addition to the above basic configuration, the apparatus according to the present invention has mode instructing means for instructing on a mode for image processing. The second compressed data is obtained by converting the first compressed data so that each block of the second compressed data has a code length equal to or different from that of each block of the first compressed data. The code length of each block of the third compressed data is made equal to that of each block of the first compressed data. Accordingly, the user's instruction on the document mode (for example, color/monochromaticity) causes unwanted data to be removed. This serves to efficiently reduce the amount of data. Furthermore, the third compressed data length has the fixed value. This enables the address calculation to be easily executed for the editing functions such as rotation regardless of the document mode.

(P7) In addition to the above basic configuration, the apparatus according to the present invention has a memory which stores the third compressed data, a decoding section which decodes the third compressed data read from the memory, a color determining section which determines whether the image is colored or monochromatic, and the mode instructing means for instructing on the mode for image processing. Then, in accordance with at least either a color determination result or mode instruction information, the second compressed data is obtained by converting the first compressed data so that each block of the second compressed data has a code length equal to or different from that of each block of the first compressed data. The code length of each block of the third compressed data is made equal to that of each block of the first compressed data. The memory can store a plurality of third compressed data having different color determination results and different mode instruction information (FIGS. 7, 9, 10, and 11). Accordingly, the user's instruction on the document mode (for example, color/monochromaticity) causes unwanted data to be removed. This serves to efficiently reduce the amount of data. Therefore, unwanted data is removed in response to the user's instruction on the document mode, an ACS result, or the like. This serves to efficiently reduce the amount of data. Furthermore, the third compressed data length has the fixed value. This enables the address calculation to be easily executed for the editing functions such as rotation. Moreover, a plurality of formats can be used for the memory. This enables the processing of a mixture of data processed in different modes.

(P8) As described in FIG. 10, the apparatus according to the present invention has a dividing section which divides the image into blocks, a color determining section which determines whether each pixel is colored or monochromatic, and a block color correcting section which generates, from the result of the determination by the color determining section, a result of determination as to whether each block is colored or monochromatic. Accordingly, an ACS result is produced for each particular area. This allows ACS results to be more freely utilized.

(P9) The apparatus according to the present invention has a dividing section which divides the image into blocks and a color determining section which determines whether each of the blocks is colored or monochromatic. Accordingly, an ACS result is produced for each particular area. This allows ACS results to be more freely utilized.

(P10) The apparatus according to the present invention has a dividing section which divides the image into blocks, a compressing section which compresses each block of the image to generate compressed data, and a color determining section which determines whether the entire image or each predetermined unit of it is colored or monochromatic. The compressed data retains the result of determination as to whether it is colored or monochromatic. Thus, an ACS result is produced for each coding unit. This improves the efficiency of coding of compressed data and makes the data more versatile.

(P11) The present invention has a dividing section which divides an image into blocks, a compressing section which compresses each block of the image into compressed data, a color determining section which determines whether the entire image or its predetermined unit is colored or monochromatic, and a compressed data extracting means for extracting arbitrary compressed data from the above compressed data. The compressed data retains the result of the determination as to whether it is colored or monochromatic. On the basis of the result of the determination as to whether each compressed block of the extracted compressed data is colored or monochromatic, the result being retained in the compressed block, the compressed data extracting means generates information indicating whether the compressed block is colored or monochromatic. Thus, an ACS result is produced for each coding unit. Therefore, even if only the compressed data for an arbitrary area is extracted from the compressed data, the ACS result suitable for that area is obtained.

(P12) The present invention has the above dividing section, the above compressing section, a color determining section which determines whether the entire image or its predetermined unit is colored or monochromatic, the above decoding section, and a switching image processing section which switch processing or process parameters depending on whether the image is colored or monochromatic. The compressed data retains the result of the determination as to whether it is colored or monochromatic. The decoding section outputs the result of the determination as to whether the compressed data is colored or monochromatic. The switching image processing section executes processing in accordance with on the result of the determination as to whether the data is colored or monochromatic. Thus, an ACS result is produced for each coding unit. This enables the processing to be switched for each compressed data, thus making the data more versatile.

(P13) The present invention has the dividing section, the compressing section, and the color determining section. The color determining section makes determinations using the compressed data. Code data can be used to make ACS determinations and has an improved versatility.

(P14) The present invention has a dividing section which divides an image into blocks, a first color determining section which outputs the first result of a determination as to whether the entire image is color or is monochromatic, a second color determining section which outputs the second result of a determination as to whether each block is color or is monochromatic, and a third color determining section which outputs the third result of a determination as to whether the block is color or is monochromatic, on the basis of the result of the first determination as to whether the entire image is color or is monochromatic as well as the result of the second determination as to whether the block image is color or is monochromatic. Accordingly, the result of an ACS determination can be corrected with reference to the results of ACS determinations based on different systems. This improves the accuracy of ACS determinations.

(P15) The present invention has an input section to which a colored image is inputted, a color determining section which outputs the result of a determination as to whether each predetermined unit of the colored image is colored or monochromatic, a colored/monochromatic image generating section which switches processing or process parameters for each predetermined unit depending on whether the predetermined unit of the inputted colored image is colored or monochromatic, to convert the predetermined unit into a colored or monochromatic image, and an image output section which outputs the image generated by the colored/monochromatic image generating section. The image output section controls the output processing depending on whether the image is uniformly colored or monochromatic in the main scanning direction of the image output section. For example, the image output section controls the output of one or both of the colored and monochromatic images.

Thus, an ACS result is outputted for each print line. Accordingly, for example, for an image containing colors only in a very small area, only a monochromatic printing section needs to be moved. This reduces the fatigue of the printing section.

(P16) The present invention has the above first compressing section, the above first code converting section, the above second code converting section, the above decoding section, and a plane analysis section which analyzes plane information for each block. In accordance with the plane information, the second compressed data is obtained by converting the first compressed data so that each block of the second compressed data has a code length equal to or different from that of each block of the first compressed data. The third compressed data is equal to the first compressed data for each block. This makes it possible to determine, for each color plate or for a K plane, whether or not significant information is present. Therefore, the coding efficiency is improved.

(P17) In the above apparatus, in accordance with the plane information, the second compressed data is obtained by converting the first compressed data so that each block of the second compressed data has a code length equal to or different from that of each block of the first compressed data. The third compressed data is equal to the first compressed data for each block. The plane information indicates whether or not the plane is white. This makes it possible to determine, for each color plate or for the K plane, whether or not significant information is present. Therefore, the coding efficiency is improved. Further, information on the entire image can be obtained by integrating pieces of information on the respective blocks together.

(P18) In the above apparatus, the plane information indicates whether or not the plane is white. The apparatus further has a generating section which generates plane information on the entire image from the plane information for each block. This makes it possible to determine, for each color plate or for the K plane, whether or not significant information is present. Therefore, the coding efficiency is improved. Further, information on the entire image can be obtained by integrating pieces of information on the respective blocks together.

(P19) The present invention has an input section to which a colored or monochromatic image is inputted, an image converting section which converts an image, and a compressing section which compresses the converted image. The image converting section converts the monochromatic image into a colored image format. Thus, conversions are always executed using the colored format. Consequently, an image can be obtained in which a monochromatic area in a colored part has the same level of image quality as that of a monochromatic area in a monochromatic part.

(P20) The present invention has the above first compressing section, the above first code converting section, the above second code converting section, a third code converting section which converts the second compressed data into fourth compressed data, and a decoding section which decodes the fourth compressed data. The first and fourth compressed data have a fixed length, that is, an equal code format length. The second and third compressed data have a variable length. The second compressed data is obtained by converting the first compressed data so that each block of the second compressed data has a code length equal to or different from that of each block of the first compressed data. Thus, the first code converting section reduces redundancy. Consequently, the amount of data accumulated is increased by, for example, storing the second compressed data in a hard disk device. When the second code converting section is placed between the hard disk device and an external application so as to transfer data between them, codes are converted so as to be utilized by the external application. Accordingly, the second compressed data with the reduced redundancy is provided to the hard disk device and second code converting section. Therefore, the data can be more efficiently transferred.

(P21) The present invention has the above first compressing section, the above first code converting section, the above second code converting section, a third code converting section which converts each block of the fourth compressed data into fifth compressed data, a fourth code converting section which converts the second or fifth compressed data into sixth compressed data, and a decoding section which decodes the sixth compressed data. The first and sixth compressed data have a fixed length, that is, an equal code format length. The second, third, fourth, and fifth compressed data have a variable length. The second compressed data is obtained by converting the first compressed data so that each block of the second compressed data has a code length equal to or different from that of each block of the first compressed data.

Thus, the first code converting section reduces redundancy. Consequently, the amount of data accumulated is increased by, for example, storing the second compressed data in the hard disk device. When the second and third code converting sections are placed between the hard disk device and the external application so as to transfer data between them, the external application can utilize compressed data generated by the first compressing section. Furthermore, the decoding section can utilize codes from the external application. Accordingly, the second and fifth compressed data with the reduced redundancy are provided to the hard disk device and second and third code converting sections. Therefore, the data can be more efficiently transferred.

(P22) The present invention has the above first compressing section, the above first code converting section, and a decoding section which decodes the second compressed data. The first compressed data is variable length data. The second compressed data is fixed length data. Thus, the first compressed data is variable length data with the reduced redundancy. It is thus possible to increase the amount of data accumulated in the hard disk device, without the need for extra conversions. RIP data or the like can be directly converted. For printing, the performance of editions such as rotation is improved by converting variable length data into fixed length data.

(P23) The present invention has a first compressing section which compresses an image into the first or second compressed data, a first code converting section which converts the second compressed data into the third compressed data, and a decoding section which decodes the first or third compressed data. The first and third compressed data have a fixed length. The second compressed data is variable length data. Thus, in RIP or the like, when an image is to be immediately printed as in the case of single page printing, printing is directly carried out without using the hard disk device or the like. When an image is to be printed after a certain amount of data has been accumulated as in the case of multiple page printing, the data is stored directly in the hard disk device without using a PM or the like. This eliminates the need for extra data transfers or conversions to improve the performance.

(P24) As shown in FIG. 18, the present invention provides an image processing apparatus having the first compressing section, a first code converting section 2009 which converts the first compressed data into the second compressed data, a second code converting section 2010 which converts the second compressed data into the third compressed data, a third code converting section 2004 which converts the fourth compressed data into the fifth compressed data, and a decoding section 2006 which decodes the third or fifth compressed data, wherein the third and fifth compressed data have an equal code format length. Since the third and fifth compressed data have the equal code format length, it is possible to rotate or print a mixture of code data generated by different processes executed by, for example, a copier and printer.

(P25) The apparatus according to the present invention has the first compressing section which compresses an image into first compressed data, the first code converting section which converts the first compressed data into the second compressed data, the second code converting section which converts the second compressed data into the third compressed data, the third code converting section which converts the fourth compressed data into the fifth compressed data, and the decoding section which decodes the third or fifth compressed data. When a mixture of the third and fifth compressed data is printed on a page, an equal sub-scanning resolution and an equal sub-scanning processing unit are used on the same main scanning line. Since the equal sub-scanning resolution is used on the main scanning line when the mixed data is used, a mixture of data with various resolutions can be outputted.

(P26) The apparatus has the above first compressing section, the above second code converting section, a third code converting section which converts the fourth compressed data into the fifth compressed data, a memory which stores the third or fifth compressed data, and a decoding section which decodes the third or fifth compressed data stored in the memory. If the third or fifth compressed data is independently stored in or read from the memory, it is stored in the memory in its own compressed format. If a mixture of the third and fifth compressed data is stored in or read from the memory, the third and fifth compressed data are converted in such a way that a plurality of blocks constitutes one processing block so that the third and fifth compressed data use an equal processing block unit.

Thus, different processing units are used for a mixture of different formats and for a single format. This allows the memory to be more efficiently used.

(P27) An apparatus for image processing has a first compressing section which converts a multivalued image into first compressed data, a first code converting section which converts the first compressed data into second compressed data, a second code converting section which converts the second compressed data into third compressed data, a third data converting section which converts an binary image into fourth binary data corresponding to each compressing process unit for the first compressed data, and a decoding section which decodes the third compressed data and the fourth binary data. Here, the first and third compressed data and the fourth binary data have an equal code format length.

Thus, the multivalued compressed data and the binary data have the same processing unit and the equal format length. It is therefore possible to process a mixture of data having different signal bits and used for, for example, a copier (multivalued values) and a printer (binary values).

(P28) An apparatus for image processing has a first compressing section which compresses each block of a colored image into first compressed data, a first code converting section which converts the first compressed data into second compressed data, a second code converting section which converts the second compressed data into third compressed data, a third code converting section which converts fourth compressed data into each block of fifth compressed data, a fourth code converting section which converts the second or fifth compressed data into sixth compressed data, and a decoding section which decodes the sixth compressed data.

Here, the first and sixth compressed data have a fixed length. The second, third, fourth, and fifth data have a variable length. The second compressed data is obtained by converting the first compressed data so that each block of the second compressed data has a code length equal to or different from that of each block of the first compressed data. The fourth code converting section forces a conversion into a specified format.

Thus, when the first compressed data stored in, for example, the hard disk device is to be taken out as scan data, it is in a colored state. When the monochromatic printing section is to take this data out for printing, the first code converting section converts it into monochromatic data. This makes the data more versatile and reduces the amount of data that must be handled by the printing section.

(P29) An apparatus for image processing has a first compressing section which compresses each block of a colored image into first compressed data, a first code converting section which converts the first compressed data into second compressed data, a second code converting section which converts the second compressed data into third compressed data, a third code converting section which converts fourth compressed data into each block of fifth compressed data, a fourth code converting section which converts the second or fifth compressed data into sixth compressed data, a decoding section which decodes the sixth compressed data, and a color determining section which determines whether the colored image is colored or monochromatic.

Here, the first and sixth compressed data have a fixed length. The second, third, fourth, and fifth data have a variable length. The second compressed data is obtained by converting the first compressed data in accordance with the result of the color determination so that each block of the second compressed data has a code length equal to or different from that of each block of the first compressed data. The fourth code converting section forces a conversion into a monochromatic format having a shorter code length than a first code format.

Thus, the ACS makes it possible to select whether the first code converting section will simply discard color information (in the case of a monochromatic image) or utilizes the color information to obtain a monochromatic signal (in the case of a colored image). This improves the quality of a monochromatic image.

(P30) An apparatus for image processing has a first compressing section which compresses each block of a colored image into first compressed data, a first code converting section which converts the first compressed data into second compressed data, a second code converting section which converts the second compressed data into third compressed data, a third code converting section which converts fourth compressed data into each block of fifth compressed data, a fourth code converting section which converts the second or fifth compressed data into sixth compressed data, a decoding section which decodes the sixth compressed data, and a color determining section which determines whether the colored image is colored or monochromatic.

Here, the first and sixth compressed data have a fixed length. The second, third, fourth, and fifth data have a variable length. The second compressed data is obtained by converting the first compressed data in accordance with the result of the color determination so that each block of the second compressed data has a code length equal to or different from that of each block of the first compressed data. The fourth code converting section executes a conversion into a format having the same code length as that of the first code format. Thus, the first and third code lengths are equal, so that, for example, data can be handled in the same manner when an image is inputted for a scan and copy processes and when an image is outputted for a copy process. This simplifies the processing. Moreover, the second compressed data, which has a shorter code length, is stored in the hard disk device or the like. This efficiently reduces the amount of data.

Description will be given of the connections between the above points and the drawings. The embodiment mainly illustrated in FIG. 1 includes the points P1, P2, P3, P4, P5, P6, P7, P8, P10, P12, P13, P14, and P15. The embodiment mainly illustrated in FIG. 12 includes the points P9, P16, P17, P18, and P19. The embodiment mainly illustrated in FIG. 16 includes the points P11, P20, and P21. The embodiment mainly illustrated in FIG. 17 includes the points P22 and P23. The embodiment mainly illustrated in FIG. 18 includes the points P24, P25, and P26. The embodiment mainly illustrated in FIG. 22 includes the point P27. The embodiment mainly illustrated in FIG. 24 includes the points P28, P29, and P30.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for image processing comprising:
a first compressing section which compresses each block of an image into first compressed data;
a first code converting section which converts the first compressed data into second compressed data so that each block of the second compressed data has a code length equal to or different from that of each block of the first code length;
a second code converting section which converts the second compressed data into third compressed data so that each block of the third compressed data has a code length equal to that of each block of the first code length; and
a decoding section which decodes the third compressed data.

2. The apparatus for image processing according to claim 1, wherein the decoding section also decodes the first compressed data.

3. The apparatus for image processing according to claim 1, further comprising a color determining section which determines whether the image is colored or monochromatic,
wherein the first code converting section converts the first compressed data into the second compressed data in accordance with the result of the determination by the color determining section so that each block of the second compressed data has a code length equal to or different from that of each block of the first compressed data, and
the first code converting section converts the second compressed data into the third compressed data in accordance with the result of the determination by the color determining section so that each block of the third compressed data has a code length equal to that of each block of the second compressed data.

4. The apparatus for image processing according to claim 1, wherein the decoding section executes decoding the compressed data in a code format of the first compressed data, and
the second code converting section converts the second compressed data into the third compressed data so that each block of the third compressed data has a code length and a code format equal to those of each block of the first compressed data.

5. The apparatus for image processing according to claim 1, wherein if the third compressed data has a code format different from that of the first compressed data, the decoding section decodes the third compressed data by converting the code format of the third compressed data into a code format of the first compressed data.

6. The apparatus for image processing according to claim 1, further comprising mode instructing means for instructing on a mode for image processing,
wherein the first code converting section converts the first compressed data into the second compressed data in accordance with the mode instructed on by the mode instructing means so that each block of the second compressed data has a code length equal to or different from that of each block of the first compressed data, and
the first code converting section converts the second compressed data into the third compressed data so that each block of the third compressed data has a code length equal to that of each block of the first compressed data.

7. The apparatus for image processing according to claim 1, further comprising a memory which stores the third compressed data;
a color determining section which determines whether the image is colored or monochromatic; and
mode instructing means for instructing on a mode for image processing,
wherein the decoding section decodes the third compressed data read from the memory,
in accordance with at least either a color determination result produced by the color determining section or the mode instructed on by the mode instructing means, the first code converting section converts the first compressed data into the second compressed data so that each block of the second compressed data has a code length equal to or different from that of each block of the first compressed data, and
the memory stores plural types of third compressed data having different color determination results and different pieces of mode instruction information.

8. An apparatus for image processing comprising:
a dividing section which divides an image into blocks;
a color determining section which determines whether the image is colored or monochromatic; and
a block color determining section which determines whether each of the blocks is colored or monochromatic, on the basis of the result of the determination by the color determining section.

9. An apparatus for image processing comprising:
a dividing section which divides an image into blocks; and
a block color determining section which determines whether each of the blocks is colored or monochromatic.

10. An apparatus for image processing comprising:
a dividing section which divides an image into blocks;
a color determining section which determines whether the image is colored or monochromatic; and
a compressing section which compresses each of the blocks into which the image has been divided by the dividing section, together with the result of the determination of a full image plane by the color determining section.

11. The apparatus for image processing according to claim 10, wherein the color determining section makes determination for each of the blocks into which the image has been divided by the dividing section, and
the compressing section compresses each of the blocks into which the image has been divided by the dividing section, together with the result of the determination for the each block which result is produced by the color determining section.

12. The apparatus for image processing according to claim 10, wherein the color determining section makes determination for the entire image, and
the compressing section compresses each of the blocks into which the image has been divided by the dividing section, together with the result of the determination for the entire image which result is produced by the color determining section.

13. The apparatus for image processing according to claim 10, further comprising compressed data extracting means for extracting arbitrary compressed data from the compressed data obtained by compressing each of the blocks, extracting the determination result from the compressed data, and generating a second determination result from the determination result.

14. The apparatus for image processing according to claim 10, further comprising a decoding section which decodes the compressed data to generate a second determination result from the determination result produced by the color determining section and compressed together with the image; and
image processing section which executes image processing on the image in accordance with the second determination result generated by the decoding section.

15. An apparatus for image processing comprising:
a dividing section which divides an image into blocks;
a compressing section which compresses each of the blocks into which the image has been divided by the dividing section, to generate compressed data for each block; and
a color determining section which determines whether the image is colored or monochromatic, on the basis of the compressed data for each block.

16. An apparatus for image processing comprising:
a dividing section which divides an image into blocks,
a first color determining section which determines whether the entire image is colored or monochromatic and then outputs a first determination result;
a second color determining section which determines whether each block of the image is colored or monochromatic and then outputs a second determination result; and
a third color determining section which outputs a third determination result on the basis of the first determination result and the second determination result.

17. An apparatus for image processing comprising:
an input section to which an image is inputted;
a color determining section which determines whether each line of the image is colored or monochromatic and then outputs a determination result;
a colored/monochromatic image generating section which converts each predetermined unit of the image into a colored and monochromatic images, in accordance with the determination result outputted by the color determining section; and
an image output section which outputs the colored and monochromatic images generated by the colored/monochromatic image generating section, in accordance with the determination result outputted by the color determining section.

18. An apparatus for image processing comprising:
a plane analysis section which analyzes image plane information for each block of the image;
a compressing section which compresses each block of the image into first compressed data;
a first code converting section which converts the first compressed data into second compressed data in accordance with the plane information so that each block of the second compressed data has a code length equal to or different from that of each block of the first compressed data; and
a second code converting section which converts the second compressed data into third compressed data so that each block of the third compressed data has a code length equal to that of each block of the first compressed data.

19. The apparatus for image processing according to claim 18, wherein the plane information indicates whether or not the plane is white.

20. The apparatus for image processing according to claim 19, further comprising a generating section which generates plane information on the entire image from the plane information for each block.

21. An apparatus for image processing comprising:
an input section to which a colored image and a monochromatic image are inputted;
an image converting section which converts a monochromatic image format into a colored image format; and
a compressing section which compresses the colored image and the monochromatic image converted by the image converting section.

22. An apparatus for image processing comprising:
a compressing section which compresses each block of an image into first compressed data;
a first code converting section which converts the first compressed data into second compressed data so that the block of the second compressed data has code length equal to and different from that of the block of the first compressed data;
a second code converting section which converts the second compressed data into third compressed data with a variable code length;
a third code converting section which converts the second compressed data into fourth compressed data having a fixed code length equal to that the first compressed data; and
a decoding section which decodes the fourth compressed data.

23. An apparatus for image processing comprising:
a compressing section which compresses each block of an image into first compressed data with a fixed code length;
a first code converting section which converts the first compressed data into second compressed data so that the block of the second compressed data have code length equal to and different from that of the block of the first compressed data;
a second code converting section which converts the second compressed data into third compressed data with a variable code length;
a third code converting section which converts each block of externally inputted fourth compressed data with a variable code length into fifth compressed data with a variable code length;
a fourth code converting section which converts the second and fifth compressed data into sixth compressed data having a code length equal to that of the first compressed data; and
a decoding section which decodes the sixth compressed data.

24. An apparatus for image processing comprising:
a compressing section which compresses each block of an image into first compressed data with a variable code length;
a first code converting section which converts the first compressed data into second compressed data with a fixed code length; and
a decoding section which decodes the second compressed data.

25. An apparatus for image processing comprising:
a compressing section which compresses an image into first compressed data with a fixed code length and second compressed data with a variable code length;
a first code converting section which converts the second compressed data into third compressed data with a fixed code length; and
a decoding section which decodes the first or third compressed data.

26. An apparatus for image processing comprising:
a compressing section which compresses an image into first compressed data;
a first code converting section which converts the first compressed data into second compressed;
a second code converting section which converts the second compressed data into third compressed data;
a third code converting section which converts externally inputted fourth compressed data into fifth compressed data having a code length equal to that of the third compressed data; and
a decoding section which decodes the third or fifth compressed data.

27. The apparatus for image processing according to claim 26, wherein when an image based on both third and fifth compressed data is printed on the same page, an equal sub-scanning-wise resolution and an equal sub-scanning-wise processing unit are used on a main scanning line.

28. An apparatus for image processing comprising:
a compressing section which compresses each block of an image into first compressed data;
a first code converting section which converts the first compressed data into second compressed data;
a second code converting section which converts the second compressed data into third compressed data;
a third code converting section which converts externally inputted fourth compressed data into fifth compressed data;
a memory which operates when storing, of the third and fifth compressed data, only the third compressed data, to store the third compressed data compressed for each block, in a format of the third compressed data,
the memory operating when storing, of the third and fifth compressed data, only the fifth compressed data, to store the fifth compressed data compressed for each block, in a format of the fifth compressed data,
the memory operating when storing both third and fifth compressed data, to store the third and fifth compressed data in one of the formats of the third and fifth compressed data which has a larger code length; and
a decoding section which decodes the third or fifth compressed data stored in the memory.

29. An apparatus for image processing comprising:
a compressing section which converts each block of a multivalued image into first compressed data in the predetermined format;
a first code converting section which converts the first compressed data into second compressed data;
a second code converting section which converts the second compressed data into third compressed data in the predetermined format;
a third data converting section which converts each block of an binary image into fourth compressed data in the predetermined format; and
a decoding section which decodes the third or fourth compressed data.

30. An apparatus for image processing comprising:
a compressing section which compresses each block of an image into first compressed data with a fixed code length;
a first code converting section which converts the first compressed data into second compressed data with a variable code length;
a second code converting section which converts the second compressed data into third compressed data with a variable code length;
a third code converting section which converts each block of externally inputted fourth compressed data with a variable code length into fifth compressed data with a variable code length;
a fourth code converting section which converts the second and fifth compressed data into sixth compressed data having a fixed code length and a predetermined format; and
a decoding section which decodes the sixth compressed data.

31. The apparatus for image processing according to claim 30, further comprising:
a color determining section which determines whether the image is colored or monochromatic,
wherein the second code converting section converts the second compressed data into the third compressed data in accordance with the result of the determination by the color determining section so that each block of the third compressed data has a code length equal to or different from that of each block of the first compressed data; and
the fourth code converting section converts the second and fifth compressed data into the sixth compressed data having the fixed code length shorter than those of the formats of the second and fifth compressed data and having a monochromatic format.

32. The apparatus for image processing according to claim 30, wherein the fourth code converting section converts the second and fifth compressed data into the sixth compressed data in a format having the fixed code length and the same fixed code length as that of the format of the first compressed data.
Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.
